(19) United States
(12) Patent Application Publication
(10) Pub. No.: US 2016/0272848 A1
(43) Pub. Date: Sep. 22, 2016

(54) DOUBLE-SIDED ADHESIVE SHEET FOR FIXING PORTABLE-ELECTRONIC-DEVICE MEMBERS, AND PORTABLE-ELECTRONIC-DEVICE PRODUCTION METHOD

(71) Applicant: NITTO DENKO CORPORATION, Ibaraki-shi, Osaka (JP)

(72) Inventors: Toshihide SUZUKI, Ibaraki-shi, Osaka (JP); Naoki NAKAYAMA, Ibaraki-shi, Osaka (JP)

(73) Assignee: NITTO DENKO CORPORATION, Ibaraki-shi, Osaka (JP)

(21) Appl. No.: 15/034,041

(22) PCT Filed: Oct. 22, 2014
(86) PCT No.: PCT/JP2014/078042

§ 371 Date: May 3, 2016

(30) Foreign Application Priority Data
Nov. 5, 2013 (JP) 2013-229850
Jul. 7, 2014 (JP) 2014-139591

(51) Int. Cl. C09J 7/00; C09J 133/08; C09J 5/00

(52) U.S. Cl. CPC C09J 7/00; C09J 5/00; C09J 133/08; C09J 2203/326; C09J 2205/31; C09J 2433/00

(57) ABSTRACT

Provided is a double-sided pressure-sensitive adhesive sheet for securing portable electronic device members. This double-sided pressure-sensitive adhesive sheet, when used for securing a constitutional member in a portable electronic device, surely offers high adhesive strength even when used in a small area. In addition, the double-sided pressure-sensitive adhesive sheet restrains separation of the constitutional member even when the portable electronic device is subjected to drop impact. Also provided is a method for producing a portable electronic device using the double-sided pressure-sensitive adhesive sheet for securing portable electronic device members. A double-sided pressure-sensitive adhesive sheet according to the present invention for securing portable electronic device members includes an acrylic pressure-sensitive adhesive layer capable of curing by radiation irradiation. The acrylic pressure-sensitive adhesive layer has a glass transition temperature after curing of −30° C. or lower and has a storage modulus after curing of 6.0×10⁴ Pa or more at 70° C.

### TECHNICAL FIELD

The present invention relates to double-sided pressure-sensitive adhesive sheets for securing portable electronic device members, and to methods for producing portable electronic devices.

### BACKGROUND ART

Display devices (e.g., liquid crystal displays (LCDs)) and portable input devices (e.g., touch screens) for use in combination with the display devices have been more commonly used in various areas. Typically in the production of these display devices and input devices, double-sided pressure-sensitive adhesive sheets (double-sided pressure-sensitive adhesive tapes) are used for securing various members and modules. For example, there is known a double-sided pressure-sensitive adhesive sheet that has impact resistance and is used for waterproofing in portable electronic devices. This double-sided pressure-sensitive adhesive sheet includes a foamed substrate and a pressure-sensitive adhesive layer (see Patent Literature (PTL) 1).

However, in some portable electronic devices such as smartphones, the area in which a glass lens is secured by a double-sided pressure-sensitive adhesive sheet decreases with an increasing screen area of a touch screen. In contrast, some other portable electronic devices have a structure in which a touch screen structure or an LCD module is disposed directly on a lens made typically of glass. In these portable electronic devices, a portion for securing the lens made typically of glass supports an increasing load. This requires ever-higher adhesiveness of double-sided pressure-sensitive adhesive sheets for use in the portable electronic devices. Disadvantageously, however, conventional double-sided pressure-sensitive adhesive tapes may fail to offer such desired high adhesive strength, but may undergo separation.

As a possible solution to solve the disadvantage, there is proposed a curable pressure-sensitive adhesive tape that is cured by photo-radical curing and offers high adhesive strength (see PTL 2). The curable pressure-sensitive adhesive tape has certain strength, but fails to offer satisfactory impact resistance. There is also proposed a curable pressure-sensitive adhesive tape that is cured by photo-cationic curing (see PTL 3). The curable pressure-sensitive adhesive tape has certain strength, but fails to offer satisfactory impact resistance. Specifically, the pressure-sensitive adhesive tapes as mentioned above, when used typically in portable electronic devices and the portable electronic devices are dropped off, may undergo separation due to drop impact.

### CITATION LIST

### Patent Literature

PTL 1: Japanese Unexamined Patent Application Publication (JP-A) No. 2009-108314

PTL 2: JP-A No. 2005-239856

PTL 3: Japanese Unexamined Patent Application Publication (Translation of PCT Application) (JP-A) No. 2009-513777

### SUMMARY OF INVENTION

### Technical Problem

Accordingly, the present invention has an object to provide a double-sided pressure-sensitive adhesive sheet for securing portable electronic device members as follows. This double-sided pressure-sensitive adhesive sheet, when used for securing a constitutional member in a portable electronic device, surely offers high adhesive strength even when used in a small area in the portable electronic device. In addition, the double-sided pressure-sensitive adhesive sheet can eliminate or minimize the separation of the constitutional member even when the portable electronic device is subjected to drop impact.

The present invention has another object to provide a method for producing a portable electronic device using the double-sided pressure-sensitive adhesive sheet for securing portable electronic device members.

### Solution to Problem

The inventors of the present invention made intensive investigations to achieve the objects and, as a result, found a double-sided pressure-sensitive adhesive sheet for securing portable electronic device members, where the double-sided pressure-sensitive adhesive sheet includes an acrylic pressure-sensitive adhesive layer that is curable by irradiation with radiation and has a glass transition temperature after curing of −30° C. or lower and a storage modulus after curing of 6.0×10⁴ Pa or more at 70° C. The inventors found that this double-sided pressure-sensitive adhesive sheet surely has higher adhesiveness as compared with conventional double-sided adhesive tapes and can eliminate or minimize the separation of the constitutional member even when the portable electronic device is subjected to drop impact. The present invention has been made based on these findings.

In particular, the storage modulus at 70° C. is specified in the present invention. Specifically, when the double-sided pressure-sensitive adhesive sheet according to the present invention for securing portable electronic device members is used to secure a member, strain and/or minute pressing force (push out force) is applied onto the member during use, and this causes a separation phenomenon at a very low speed. The inventors have considered that the low-speed separation phenomenon has a correlation with the storage modulus at 70° C. and have made the present invention.

Specifically, the present invention provides, in one aspect, a double-sided pressure-sensitive adhesive sheet for securing portable electronic device members, where the double-sided pressure-sensitive adhesive sheet includes an acrylic pressure-sensitive adhesive layer that is curable by irradiation with radiation. The acrylic pressure-sensitive adhesive layer has a glass transition temperature after curing of −30° C. or lower. The acrylic pressure-sensitive adhesive layer has a storage modulus after curing of 6.0×10⁴ Pa or more at 70° C.

In particular, a glass transition temperature of the acrylic pressure-sensitive adhesive layer, after curing, is preferably −30° C. or lower, where the curing is performed by irradiating the acrylic pressure-sensitive adhesive layer with an ultraviolet ray at a cumulative dose of 3000 mJ/cm² or more; and a storage modulus of the acrylic pressure-sensitive adhesive layer, after curing, is preferably 6.0×10⁴ Pa or more at 70° C., where the curing is performed by irradiating the acrylic pressure-sensitive adhesive layer with an ultraviolet ray at a cumulative dose of 3000 mJ/cm² or more.

The acrylic pressure-sensitive adhesive layer is preferably derived from a radiation-curable pressure-sensitive adhesive composition that includes an acrylic copolymer, at least one of a multifunctional acrylic oligomer (m1) and a basic monomer (m2), and a photoinitiator.

The multifunctional acrylic oligomer (m1) preferably contains three or more (meth)acryloyl groups per molecule. The multifunctional acrylic oligomer (m1) preferably has a weight-average molecular weight of 500 to 30000.

In the double-sided pressure-sensitive adhesive sheet according to the present invention for securing portable electronic device members, the radiation-curable pressure-sensitive adhesive composition preferably contains 5 to 30 parts by mass of the multifunctional acrylic oligomer (m1) and 0.05 to 5 parts by mass of the photoinitiator, per 100 parts by mass of the acrylic copolymer.

In the present invention, the basic monomer (m2) is preferably a monomer containing at least one of an amido group and an amino group in molecule and preferably has a boiling point of 120° C. or higher.

In particular, when the radiation-curable pressure-sensitive adhesive composition contains the basic monomer (m2), the acrylic copolymer is preferably derived from components including 0.5% to 10% by mass of an acidic-group-containing monomer.

In the double-sided pressure-sensitive adhesive sheet according to the present invention for securing portable electronic device members, the radiation-curable pressure-sensitive adhesive composition preferably contains 0.1 to 20 parts by mass of the basic monomer (m2) and 0.05 to 5 parts by mass of the photoinitiator, per 100 parts by mass of the acrylic copolymer.

The acrylic copolymer for use in the present invention preferably has a weight-average molecular weight of 40×10⁴ to 200×10⁴.

In addition, the present invention provides a method for producing a portable electronic device. The method includes holding a portable electronic device member using the double-sided pressure-sensitive adhesive sheet for securing portable electronic device members. Irradiation with radiation is then performed.

In the present invention, the radiation is preferably applied to a portion to be irradiated at a light incident angle of 8° to 20°. In particular, the light incident angle is preferably controlled within the range of 8° to 20° using a prism. For example, assume that radiation, when applied from one direction, such as from above, fails to sufficiently reach a portion to be irradiated. In this case, the radiation is preferably applied so that a light incident angle to the portion to be irradiated is 8° to 20°. In particular, a prism is preferably used to control the light incident angle within the range of 8° to 20°.

### Advantageous Effects of Invention

The double-sided pressure-sensitive adhesive sheet according to the present invention for securing portable electronic device members, when used to secure a constitutional member in a portable electronic device, surely has high adhesive strength even when used in a small area. In addition, the double-sided pressure-sensitive adhesive sheet can eliminate or minimize the separation of the constitutional member even when the portable electronic device is subjected to drop impact. The method according to the present invention for producing a portable electronic device simply gives a portable electronic device that has excellent reliability.

### BRIEF DESCRIPTION OF DRAWINGS

FIGS. 1(a) and 1(b) are a schematic top view and a schematic cross-sectional view taken along the line A-A′, respectively, of an evaluation sample for use in measurement of push out force;

FIG. 2 is a cross-sectional diagram illustrating how to measure the push out force.

FIGS. 3(a) and 3(b) are a schematic top view and a schematic cross-sectional view taken along the line B-B′, respectively, of an evaluation sample for use in measurement of drop impact resistance;

FIG. 4 is a cross-sectional diagram illustrating an incident angle of radiation;

FIG. 5 is a schematic perspective diagram illustrating how to apply radiation using a prism;

FIG. 6 is a three-view drawing of a prism, which is usable in the method according to the present invention for producing a portable electronic device;

FIGS. 7(a) and 7(b) are a schematic top view and a schematic cross-sectional view taken along the line C-C′, respectively, of an evaluation sample for use in measurement of push out force in Example 7;

FIG. 8 is a cross-sectional diagram illustrating how to measure the push out force;

FIG. 9 is a schematic view of a glass plate for use in the preparation of a prism and illustrates exemplary dimensions of the glass plate;

FIG. 10 is a schematic view of a glass plate for use in the preparation of a prism and illustrates exemplary dimensions of the glass plate;

FIGS. 11(a), 11(b), and 11(c) are a schematic top view, a schematic front view, and a schematic side view, respectively, of an exemplary prism; and

FIG. 12 is a schematic view of a prism disposed on a glass surface of an evaluation sample and illustrates an exemplary arrangement of the prism.

### DESCRIPTION OF EMBODIMENTS

The double-sided pressure-sensitive adhesive sheet according to the present invention for securing portable electronic device members includes an acrylic pressure-sensitive adhesive layer that is curable by radiation irradiation. After curing, the acrylic pressure-sensitive adhesive layer has a glass transition temperature of −30° C. or lower and has a storage modulus of 6.0×10⁴ Pa or more at 70° C. For example, the double-sided pressure-sensitive adhesive sheet may be a double-sided pressure-sensitive adhesive sheet for securing portable electronic device members, where the double-sided pressure-sensitive adhesive sheet includes an acrylic pressure-sensitive adhesive layer that will be cured by radiation irradiation after the double-sided pressure-sensitive adhesive sheet is applied to adherends. After curing, the acrylic pressure-sensitive adhesive layer has a glass transition temperature of −30° C. or lower and has a storage modulus of 6.0×10⁴ Pa or more at 70° C.

Specifically, the acrylic pressure-sensitive adhesive layer for use in the present invention is exemplified by, but not limited to, an acrylic pressure-sensitive adhesive layer that is curable by irradiation with radiation and includes, for example, a polymer component and at least one of a monomer component and a reactive oligomer component. This acrylic pressure-sensitive adhesive layer, when irradiated with radiation, undergoes a polymerization reaction and/or a crosslinking reaction of the monomer component and/or the reactive oligomer component and is cured.

In the double-sided pressure-sensitive adhesive sheet according to the present invention for securing portable electronic device members, the glass transition temperature (Tg) of the acrylic pressure-sensitive adhesive layer after curing by radiation irradiation is −30° C. or lower, preferably −35° C. or lower, and more preferably −40° C. or lower, for good adhesiveness and for adhesiveness at the instant when the resulting article is subjected to drop impact. The glass transition temperature (Tg) in terms of lower limit is generally preferably −70° C. or higher, more preferably −60° C. or higher, and furthermore preferably −50° C. or higher. The acrylic pressure-sensitive adhesive layer, if having a glass transition temperature higher than −30° C., may offer inferior adhesiveness and inferior drop impact resistance. The glass transition temperature of the acrylic pressure-sensitive adhesive layer after curing may be controlled by types, contents, and other conditions of monomer components to constitute the acrylic copolymer, and other components to be blended in the radiation-curable pressure-sensitive adhesive composition to form the acrylic pressure-sensitive adhesive layer. The glass transition temperature of the acrylic pressure-sensitive adhesive layer herein may be measured by a method described in after-mentioned working examples. Assume that the acrylic pressure-sensitive adhesive layer is cured by ultraviolet irradiation. In this case, the glass transition temperature is measured herein in such a state that the acrylic pressure-sensitive adhesive layer is cured by irradiation with an ultraviolet ray at a cumulative dose of 3000 mJ/cm² or more. The measurement may be performed in such a state that the acrylic pressure-sensitive adhesive layer is cured by irradiation at a cumulative dose of 3000 mJ/cm².

In the double-sided pressure-sensitive adhesive sheet according to the present invention for securing portable electronic device members, the storage modulus at 70° C. of the acrylic pressure-sensitive adhesive layer after curing by radiation irradiation is 6.0×10⁴ Pa or more, preferably 6.5×10⁴ Pa or more, more preferably 6.8×10⁴ Pa or more, and furthermore preferably 7.0×10⁴ Pa or more. This is for ensuring high adhesiveness and for enduring a certain load after lamination to eliminate or minimize the separation. The upper limit of the storage modulus is generally preferably 3.0×10⁵ Pa or less, more preferably 2.5×10⁵ Pa or less, and furthermore preferably 2.0×10⁵ Pa at 70° C. The acrylic pressure-sensitive adhesive layer after curing, if having a storage modulus of less than 6.0×10⁴ Pa at 70° C., may have lower adhesiveness and may undergo separation. The storage modulus of the acrylic pressure-sensitive adhesive layer, after curing, is adjustable by the type and proportion in amount of the monomer or oligomer component to be cured by radiation irradiation. The storage modulus is also controllable by the composition (formulation) of the acrylic copolymer to be used. The storage modulus of the acrylic pressure-sensitive adhesive layer may be measured by a method described in the working examples. Assume that the acrylic pressure-sensitive adhesive layer is cured by ultraviolet irradiation. In this case, the storage modulus is measured herein in such a state that the acrylic pressure-sensitive adhesive layer is cured by irradiation with an ultraviolet ray at a cumulative dose of 3000 mJ/cm² or more. The storage modulus may be measured in such a state that the acrylic pressure-sensitive adhesive layer is cured by irradiation with an ultraviolet ray at a cumulative dose of 3000 mJ/cm2.

Radiation-Curable Pressure-Sensitive Adhesive Composition

The acrylic pressure-sensitive adhesive layer in the present invention is one that is curable by radiation irradiation. The acrylic pressure-sensitive adhesive layer in the present invention is preferably derived from (formed from) a radiation-curable pressure-sensitive adhesive composition, where the composition includes an acrylic copolymer, at least one of a multifunctional acrylic oligomer (m1) and a basic monomer (m2), and a photoinitiator.

As used herein, the term “pressure-sensitive adhesive composition” refers to a composition for use to form a pressure-sensitive adhesive layer. The term “radiation-curable pressure-sensitive adhesive composition” refers to a composition for use to form a “pressure-sensitive adhesive layer that is curable by radiation irradiation”.

The radiation-curable pressure-sensitive adhesive composition contains an acrylic copolymer as a principal component. The radiation-curable pressure-sensitive adhesive composition may contain the acrylic copolymer in a content not limited, but preferably 40% by weight or more, more preferably 50% by weight or more, and furthermore preferably 60% by weight or more, based on the total amount (total weight, 100% by weight) of the radiation-curable pressure-sensitive adhesive composition. The content of the acrylic copolymer in the radiation-curable pressure-sensitive adhesive composition refers to an amount relative to the total amount of active components (total amount of solid substances). For example, assume that the radiation-curable pressure-sensitive adhesive composition is a solvent-borne radiation-curable pressure-sensitive adhesive composition including the acrylic copolymer, at least one of the multifunctional acrylic oligomer (m1) and the basic monomer (m2), and the photoinitiator. In this case, the content of the acrylic copolymer is preferably 40% by weight or more, more preferably 50% by weight or more, and furthermore preferably 60% by weight or more, relative to the total amount (100% by weight) of the acrylic copolymer, at least one of the multifunctional acrylic oligomer (m1) and the basic monomer (m2), and the photoinitiator.

It is important in the present invention to select monomer components to constitute the acrylic copolymer so that the acrylic pressure-sensitive adhesive layer, after curing, has a glass transition temperature within the range. The monomer components to constitute the acrylic copolymer preferably include, as an acrylic monomer, a (meth)acrylic alkyl ester containing a straight or branched chain alkyl group. Specifically, the acrylic copolymer is preferably a polymer derived from monomer components essentially including a (meth)acrylic alkyl ester containing a straight or branched chain alkyl group. In other words, the acrylic copolymer is preferably a polymer including a constitutional unit derived from the (meth)acrylic alkyl ester containing a straight or branched chain alkyl group. The monomer components to constitute the acrylic copolymer may include one or more copolymerizable monomers such as polar-group-containing monomers as mentioned below. As used herein, the term “(meth)acryl(ic)” refers to “acryl(ic)” and/or “methacryl(ic)” (either one or both of “acryl(ic)” and “methacryl(ic)”). The same is applied to other descriptions. The monomer components may include each of different acrylic monomers alone or in combination. Further, the monomer components may include each of different copolymerizable monomers alone or in combination.

The “glass transition temperature (Tg)” of the acrylic polymer refers to such a temperature that the acrylic polymer transits from a rubber-like state to a hard, glassy state. The glass transition temperature may be determined by measuring the temperature dependency of a loss modulus in a viscoelasticity test to plot a curve, and calculating the glass transition temperature from a peak in the plotted curve.

The (meth)acrylic alkyl ester containing a straight or branched chain alkyl group is hereinafter also simply referred to as an “alkyl (meth)acrylate”. Non-limiting examples of the alkyl (meth)acrylate include alkyl (meth)acrylates whose alkyl moiety contains 1 to 20 carbon atoms, such as methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and icosyl (meth)acrylate. The monomer components may include each of different alkyl (meth)acrylates alone or in combination.

Of the alkyl (meth)acrylates, preferred are alkyl (meth)acrylates whose alkyl moiety contains 1 to 14 carbon atoms, of which n-butyl acrylate (BA), 2-ethylhexyl acrylate (2EHA), isooctyl acrylate, and isononyl acrylate are more preferred.

The monomer components to constitute the acrylic copolymer may contain the alkyl (meth)acrylate(s) in a content of preferably 65% to 99% by weight, and more preferably 85% to 98% by weight, of the total amount (100% by weight) of the monomer components to constitute the acrylic copolymer. This is preferred for allowing the acrylic pressure-sensitive adhesive layer, after curing, to have a glass transition temperature of −30° C. or lower.

Non-limiting examples of the polar-group-containing monomers include carboxy-containing monomers such as (meth)acrylic acid, itaconic acid, maleic acid, fumaric acid, crotonic acid, and isocrotonic acid, as well as acid anhydrides of them (e.g., acid-anhydride-containing monomers such as maleic anhydride and itaconic anhydride); hydroxy-containing monomers such as 2-hydroxyethyl (meth)acrylate, 3-hydroxypropyl (meth)acrylate, 4-hydroxybutyl (meth)acrylate, 6-hydroxyhexyl (meth)acrylate, vinyl alcohol, and allyl alcohol; amido-containing monomers such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethyl(meth)acrylamide; amino-containing monomers such as aminoethyl (meth)acrylate, dimethylaminoethyl (meth)acrylate, and t-butylaminoethyl (meth)acrylate; epoxy-containing monomers such as glycidyl (meth)acrylate and methylglycidyl (meth)acrylate; cyano-containing monomers such as acrylonitrile and methacrylonitrile; heterocycle-containing vinyl monomers such as N-vinyl-2-pyrrolidone, (meth)acryloylmorpholine, N-vinylpiperidone, N-vinylpiperazine, N-vinylpyrrole, and N-vinylimidazole; sulfonate-containing monomers such as sodium vinylsulfonate; phosphate-containing monomers such as 2-hydroxyethylacryloyl phosphate; imido-containing monomers such as cyclohexylmaleimide and isopropylmaleimide; and isocyanato-containing monomers such as 2-methacryloyloxyethyl isocyanate. The monomer components may include each of different polar-group-containing monomers alone or in combination.

Of the polar-group-containing monomers, preferred are carboxy-containing monomers and hydroxy-containing monomer, of which acrylic acid (AA), 2-hydroxyethyl acrylate (HEA), and 4-hydroxybutyl acrylate (4HBA) are more preferred.

The monomer components to constitute the acrylic copolymer may include the polar-group-containing monomers in a content not limited, but preferably 1% to 10% by weight, and more preferably 1% to 6% by weight, of the total amount (100% by weight) of the monomer components. This is preferred for drop impact resistance. The monomer components, if containing the polar-group-containing monomers in an excessively high content, may cause the acrylic pressure-sensitive adhesive layer to have a higher glass transition temperature to thereby have lower drop impact resistance.

Non-limiting examples of the copolymerizable monomers also include (meth)acrylic alkoxyalkyl esters (alkoxyalkyl (meth)acrylates) such as 2-methoxyethyl (meth)acrylate, 2-ethyoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, and 4-ethoxybutyl (meth)acrylate; (meth)acrylic esters excluding the alkyl (meth)acrylates, the (meth)acrylic alkoxyalkyl esters, the polar-group-containing monomers, and multifunctional monomers, but including (meth)acrylic esters containing an alicyclic hydrocarbon group, such as cyclopentyl (meth)acrylate, cyclohexyl (meth)acrylate, and isobornyl (meth)acrylate, and (meth)acrylic esters containing an aromatic hydrocarbon group, such as phenyl (meth)acrylate, phenoxyethyl (meth)acrylate, and benzyl (meth)acrylate; vinyl esters such as vinyl acetate and vinyl propionate; aromatic vinyl compounds such as styrene and vinyltoluenes; olefins or dienes such as ethylene, butadiene, isoprene, and isobutylene; vinyl ethers such as vinyl alkyl ether; and vinyl chloride. These copolymerizable monomers are also generically referred to as “other copolymerizable monomers”.

The acrylic copolymer is obtainable by polymerizing the monomer components by a known or common polymerization procedure. Non-limiting examples of the polymerization procedure for the acrylic copolymer include solution polymerization, emulsion polymerization, and bulk polymerization procedures; as well as polymerization procedure via active energy ray irradiation (active-energy-ray-polymerization procedure). Among them, the solution polymerization procedure is preferred from the viewpoints of transparency, waterproofing, and cost. Specifically, the acrylic copolymer contained in the acrylic pressure-sensitive adhesive layer is preferably obtained by polymerizing the monomer components via solution polymerization.

The solution polymerization may be performed using any of common solvents of various types. Non-limiting examples of the solvents include esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; ketones such as methyl ethyl ketone and methyl isobutyl ketone; and any other organic solvents. Each of different solvents may be used alone or in combination.

The acrylic copolymer may have a weight-average molecular weight (Mw) not limited, but typically preferably 40×10⁴ or more, and more preferably 90×10⁴ or more. The acrylic copolymer may have a weight-average molecular weight (Mw) of preferably 200×10⁴ or less, and more preferably 150×10⁴ or less.

The weight-average molecular weight of the acrylic copolymer may be controlled typically by the type and amount of the polymerization initiator; and the temperature, time, monomer concentrations, and monomer dropping rates in the polymerization. The term “weight-average molecular weight” refers to a value that is measured by gel permeation chromatography (GPC) and calibrated with a polystyrene standard. The weight-average molecular weight may be measured by a method described in the working examples.

The solution polymerization may be performed using a polymerization initiator (in particular, a thermal polymerization initiators). Each of different polymerization initiators may be used alone or in combination.

Examples of the polymerization initiators for use in the solution polymerization include, but are not limited to, azo initiators; peroxide polymerization initiators (e.g., dibenzoyl peroxide and tert-butyl permaleate); and redox polymerization initiators. Among them, the azo initiators disclosed in JP-A No. 2002-69411 are particularly preferred. Such azo initiators are preferred because decomposed products of the initiators less remain, in the acrylic polymer, as moieties that cause outgassing (that evolve outgases) upon heating. Non-limiting examples of the azo initiators include 2,2′-azobisisobutyronitrile (hereinafter also referred of as “AIBN”), 2,2′-azobis-2-methylbutyronitrile (hereinafter also referred to as “AMBN”), dimethyl 2,2′-azobis(2-methylpropionate), and 4,4′-azobis-4-cyanovaleric acid. The amount of the polymerization initiator(s) is not limited and may fall within such a range as to be usable as a polymerization initiator to give a desired molecular weight and desired reactivity.

Non-limiting examples of the multifunctional acrylic oligomer (m1) contained in the radiation-curable pressure-sensitive adhesive composition in the present invention include polyester (meth)acrylates, epoxy (meth)acrylates, and urethane (meth)acrylates, each of which includes a skeleton typically of a polyester, epoxy, or urethane added with two or more functional groups having unsaturated double bonds, such as (meth)acryloyl groups and vinyl groups. In the present invention, epoxy (meth)acrylates and urethane (meth)acrylates are preferred, of which urethane (meth)acrylates are more preferred. These are preferred from the viewpoint of compatibility with the acrylic copolymer to offer adhesive strength and impact resistance both at high levels. The multifunctional acrylic oligomer (m1) in the present invention preferably contains three or more (meth)acryloyl groups per molecule. The radiation-curable pressure-sensitive adhesive composition may include each of different multifunctional acrylic oligomers (m1) alone or in combination.

The multifunctional acrylic oligomer (m1) in the present invention may have a weight-average molecular weight of preferably 500 to 30000, more preferably 600 to 20000, and furthermore preferably 700 to 15000. The multifunctional acrylic oligomer (m1), if having a weight-average molecular weight greater than 30000, may fail to sufficiently effectively contribute to higher adhesive strength. The multifunctional acrylic oligomer (m1), if having a weight-average molecular weight less than 500, may cause the pressure-sensitive adhesive sheet to have lower processability as a pressure-sensitive adhesive sheet and/or to have lower adhesive strength and lower holding properties, because of the low molecular weight. When the multifunctional acrylic oligomer (m1) is a commercial product, a mass-average molecular weight described typically in the catalogue may be employed as the mass-average molecular weight of the multifunctional acrylic oligomer (m1) in the present invention. The mass-average molecular weight, when determined by measurement, may be determined by measuring a value via gel permeation chromatography (GPC) and calibrating the measured value with a polystyrene standard. Specifically, the mass-average molecular weight may be measured using the HPLC8020 supplied by Tosoh Corporation with two TSKgel GMH-H (20) columns and using tetrahydrofuran solvent at a flow rate of about 0.5 mL/min.

The multifunctional acrylic oligomer (m1) may have a glass transition temperature of desirably 0° C. to 300° C., preferably 20° C. to 300° C., and furthermore preferably 40° C. to 300° C. The multifunctional acrylic oligomer (m1), if having a glass transition temperature lower than about 0° C., may cause the pressure-sensitive adhesive layer to have lower cohesive force at a temperature equal to or higher than room temperature and to have lower holding properties and/or lower adhesiveness at high temperatures.

The polyester (meth)acrylates are those obtained by preparing a hydroxy-terminated polyester from a polyhydric alcohol and a polycarboxylic acid, and allowing the hydroxy-terminated polyester to react with (meth)acrylic acid. Non-limiting examples of the polyester (meth)acrylates include ARONIX M-6xxx, 7xxx, 8xxx, and 9xxx series supplied by Toagosei Co. Ltd.

The epoxy (meth)acrylates are those obtained by allowing an epoxy resin to react with (meth)acrylic acid. Non-limiting examples of the epoxy (meth)acrylates include Ripoxy SP and VR series supplied by Showa Highpolymer Co., Ltd.; and EPDXY ESTER series, LIGHT ESTER series, and LIGHT ACRYLATE series, each supplied by Kyoeisha Chemical Co., Ltd.

The urethane (meth)acrylates are those obtained by allowing a polyol, an isocyanate, and a hydroxy(meth)acrylate to react with one another. Non-limiting examples of the urethane (meth)acrylates include Art Resin UN series supplied by Negami Chemical Industrial Co., Ltd.; NK Oligo U series supplied by Shin-Nakamura Chemical Co., Ltd.; and SHIKOH UV series supplied by Nippon Synthetic Chemical Industry Co., Ltd.

The radiation-curable pressure-sensitive adhesive layer in the present invention may contain the multifunctional acrylic oligomer (m1) in a content of preferably 5 to 30 parts by mass, and more preferably 10 to 25 parts by mass, per 100 parts by mass of the acrylic copolymer. The radiation-curable pressure-sensitive adhesive composition, if containing the multifunctional acrylic oligomer (m1) in a content less than 5 parts by mass, may fail to offer high adhesiveness. The radiation-curable pressure-sensitive adhesive composition, if containing the multifunctional acrylic oligomer (m1) in a content greater than 30 parts by mass, may cause the acrylic pressure-sensitive adhesive layer to have lower processability before curing and/or lower impact resistance after curing.

The multifunctional acrylic oligomer (m1) preferably has poor compatibility with the acrylic copolymer. The poor compatibility does not cause the acrylic pressure-sensitive adhesive layer, after curing, to have a glass transition temperature shifted to a higher region by the action of the cured components. This contributes to adhesiveness and impact resistance both at satisfactory levels. Because of this, the acrylic pressure-sensitive adhesive layer, after curing, preferably has a haze (cloudiness) of 10% or more. The acrylic pressure-sensitive adhesive layer after curing, if having a haze of 10% or less, may have a glass transition temperature shifted to a higher region by the action of the cured components due to good compatibility between the multifunctional acrylic oligomer (m1) and the acrylic copolymer. This may cause the double-sided pressure-sensitive adhesive sheet to fail to have adhesiveness and impact resistance both at satisfactory levels.

The radiation-curable pressure-sensitive adhesive composition in the present invention may contain the basic monomer (m2). As used herein, the term “basic monomer” refers to a monomer having basicity. As such “basic” monomers, monomers having a high acid dissociation constant pKa or having a low base dissociation constant pKb are preferred, namely, highly basic monomers are preferred. The term “basic monomer” refers typically to a monomer containing at least one of an amido group and an amino group in molecule. The basic monomer is cured by radiation irradiation, undergoes an acid-base interaction with the acidic group (e.g., carboxy group) in the acrylic copolymer, and offers strong bonding (adhesion).

The basic monomer (m2) in the present invention is preferably a material having such a high boiling point as not to volatilize at a drying temperature in the preparation of the pressure-sensitive adhesive tape. Specifically, the basic monomer (m2) may have a boiling point of preferably 120° C. or higher, and more preferably 130° C. or higher. Non-limiting examples of the basic monomer (m2) having this configuration include dimethylaminopropylmethacrylamide (DMAPMA) (having a boiling point of 134° C. (2 mmHg) and a pKa of 9.30) and dimethylaminopropylacrylamide (DMAPAA) (having a boiling point of 117° C. (2 mmHg) and a pKa of 10.35). Among them, DMAPMA is preferred for offering strong bonding (adhesion). The radiation-curable pressure-sensitive adhesive composition may contain each of different basic monomers (m2) alone or in combination.

The radiation-curable pressure-sensitive adhesive layer in the present invention may contain the basic monomer (m2) in a content of preferably 0.1 to 20 parts by mass, and more preferably 3 to 15 parts by mass, per 100 parts by mass of the acrylic copolymer. The radiation-curable pressure-sensitive adhesive layer, if containing the basic monomer (m2) in a content less than 0.1 part by mass, may fail to offer sufficient bond strength. The radiation-curable pressure-sensitive adhesive composition, if containing the basic monomer (m2) in a content greater than 20 parts by mass, may cause the double-sided pressure-sensitive adhesive sheet to have lower impact resistance and/or to have inferior processability as a double-sided pressure-sensitive adhesive sheet.

The basic monomer has good compatibility with the acrylic copolymer. Unlike using the multifunctional acrylic oligomer, the basic monomer highly effectively contributes to higher adhesiveness when added in a small amount, even though the basic monomer has good compatibility with the acrylic copolymer. This offers adhesiveness and impact resistance both at satisfactory levels.

Especially when the basic monomer (m2) is used, the acrylic copolymer is preferably derived from constitutive monomer components including an acidic-group-containing monomer to offer elasticity and adhesiveness at still higher levels.

The acidic-group-containing monomer is not limited, as long as being a monomer containing at least one acidic group per molecule, but is preferably selected typically from the carboxy-containing monomers, the sulfonate-containing monomers, and the phosphoric-containing monomers, out of the groups exemplified as the polar-group-containing monomers. Among them, the acidic-group-containing monomer is more preferably selected from the carboxy-containing monomers, and is furthermore preferably acrylic acid. The constitutive monomer components may include each of different acidic-group-containing monomers alone or in combination.

Assume that the acrylic copolymer is derived from constitutive monomer components including the acidic-group-containing monomer. In this case, the monomer components to constitute the acrylic copolymer may include the acidic-group-containing monomer in a proportion (content) not limited, but preferably 0.5% to 10% by mass based on the total amount (100% by weight) of the monomer components. Specifically, especially when the basic monomer (m2) is used, the acrylic copolymer is preferably derived from components including 0.5% to 10% by mass of the acidic-group-containing monomer. The proportion of the acidic-group-containing monomer is more preferably 2% to 6% by mass.

The radiation-curable pressure-sensitive adhesive composition may contain the multifunctional acrylic oligomer (m1) in combination with the basic monomer (m2). The combination use of the multifunctional acrylic oligomer (m1) and the basic monomer (m2) offers adhesive strength and drop impact resistance at high levels. The contents of the multifunctional acrylic oligomer (m1) and the basic monomer (m2) upon combination use preferably fall within the ranges as specified above for the individual components. The compositional ratio (mass ratio) of the multifunctional acrylic oligomer (m1) to the basic monomer (m2) is preferably from about 1:20 to about 40:1, more preferably from 1:15 to 30:1, and furthermore preferably from about 1:5 to about 10:1.

The radiation-curable pressure-sensitive adhesive composition in the present invention may contain a photoinitiator. Specifically, the radiation-curable pressure-sensitive adhesive composition in the present invention gives an acrylic pressure-sensitive adhesive layer, where the pressure-sensitive adhesive layer, after being applied to an adherend, can be cured by irradiation with radiation such as an electron beam and/or an ultraviolet ray. Namely, the pressure-sensitive adhesive layer can undergo radiation polymerization. When the radiation polymerization is performed with an electron beam, the radiation-curable pressure-sensitive adhesive composition does not have to necessarily contain the photoinitiator. When the radiation polymerization is performed as ultraviolet ray polymerization, the radiation-curable pressure-sensitive adhesive composition may contain the photoinitiator. In any case, the radiation-curable pressure-sensitive adhesive composition may contain each of different photoinitiators alone or in combination.

The photoinitiator is not limited, as long as capable of initiating photopolymerization and may be selected from photoinitiators generally used. Non-limiting examples of the photoinitiators include benzoin ether-, acetophenone-, α-ketol-, aromatic sulfonyl chloride-, photoactive oxime-, benzoin-, benzil-, benzophenone-, ketal-, thioxanthone-, and acylphosphine oxide-photoinitiators.

Specifically, non-limiting examples of the benzoin ether photoinitiators include benzoin methyl ether, benzoin ethyl ether, benzoin propyl ether, benzoin isopropyl ether, benzoin isobutyl ether, and 2,2-dimethoxy-1,2-diphenylethan-1-one (trade name IRGACURE 651, supplied by BASF SE). Non-limiting examples of the acetophenone photoinitiators include 1-hydroxycyclohexyl phenyl ketone (trade name IRGACURE 184, supplied by BASF SE), 4-phenoxydichloroacetophenone, 4-t-butyl-dichloroacetophenone, 1-[4-(2-hydroxyethoxy)-phenyl]-2-hydroxy-2-methyl-1-propan-1-one (trade name IRGACURE 2959, supplied by BASF SE), 2-hydroxy-2-methyl-1-phenyl-propan-1-one (trade name DAROCUR 1173, supplied by BASF SE), and methoxyacetophenone. Examples of the α-ketol photoinitiators include, but are not limited to, 2-methyl-2-hydroxypropiophenone and 1-[4-(2-hydroxyethyl)-phenyl]-2-hydroxy-2-methylpropan-1-one. A non-limiting example of the aromatic sulfonyl chloride photoinitiators is 2-naphthalenesulfonyl chloride. A non-limiting example of the photoactive oxime photoinitiators is 1-phenyl-1,2-propanedione-2-(O-ethoxycarbonyl)-oxime.

A non-limiting example of the benzoin photoinitiators is benzoin. A non-limiting example of the benzil photoinitiators is benzil. Non-limiting examples of the benzophenone photoinitiators include benzophenone, benzoylbenzoic acid, 3,3′-dimethyl-4-methoxybenzophenone, polyvinylbenzophenones, and α-hydroxycyclohexyl phenyl ketone. A non-limiting example of the ketal photoinitiators is benzil dimethyl ketal. Examples of the thioxanthone photoinitiators include, but are not limited to, thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Non-limiting examples of the acylphosphine photoinitiators include bis(2,6-dimethoxybenzoyl)phenylphosphine oxide, bis(2,6-dimethoxybenzoyl)-(2,4,4-trimethylpentyl)phosphine oxide, bis(2,6-dimethoxybenzoyl)-n-butylphosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)-(2-methylpropane-1-yl)phosphine oxide, bis(2-methoxybenzoyl)-(1-methylpropane-1-yl)phosphine oxide, bis(2,6-diethoxybenzoyl)-(2-methylpropane-1-yl)phosphine oxide, bis(2,6-diethoxybenzoyl)-(1-methylpropane-1-yl)phosphine oxide, bis(2,6-dibutoxybenzoyl)-(2-methylpropane-1-yl)phosphine oxide, bis(2,4-dimethoxybenzoyl)-(2-methylpropane-1-yl)phosphine oxide, bis(2,4,6-trimethylbenzoyl)-(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl-benzyl-butylphosphine oxide, 2,6-dimethoxybenzoyl-benzyl-octylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide (trade name IRGACURE 819, supplied by BASF SE), bis(2,6-dimethoxybenzoyl)-2,4,4-trimethylpentylphosphine oxide, bis(2,4,6-trimethylbenzoyl)isobutylphosphine oxide, 2,6-dimethythoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

The amount of the photoinitiator is not limited, but is preferably 0.05 part by mass to 5 parts by mass, more preferably 0.1 part by mass to 3 parts by mass, and furthermore preferably 0.2 part by mass to 1.5 parts by mass, per 100 parts by mass of the acrylic copolymer. The photoinitiator, if used in an amount less than 0.05 part by mass, may cause an insufficient curing reaction. The photoinitiator, if used in an amount greater than 5 parts by mass, may absorb the ultraviolet ray and may cause the ultraviolet ray to fail to reach the inside of the pressure-sensitive adhesive layer. This may cause the curing reaction to proceed insufficiently and may cause the formed pressure-sensitive adhesive layer to have lower cohesive force and lower adhesive strength.

The radiation-curable pressure-sensitive adhesive composition in the present invention may contain a crosslinking agent. The presence of the crosslinking agent imparts cohesive force to the acrylic pressure-sensitive adhesive layer before radiation curing and allows the acrylic pressure-sensitive adhesive layer to have better processability and/or better workability.

The crosslinking agent is not limited, but is exemplified by isocyanate-, epoxy-, melamine-, peroxide-, urea-, metal alkoxide-, metal chelate-, metal salt-, carbodiimide-, oxazoline-, aziridine-, and amine-crosslinking agents. The radiation-curable pressure-sensitive adhesive composition may contain each of different crosslinking agents alone or in combination.

Non-limiting examples of the isocyanate crosslinking agents (multifunctional isocyanate compounds) include lower-aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; and aromatic polyisocyanates such as 2,4-tolylene diisocyanate, 2,6-tolylene diisocyanate, 4,4′-diphenylmethane diisocyanate, and xylylene diisocyanates. The isocyanate crosslinking agents may also be selected from commercial products such as trimethylolpropane/tolylene diisocyanate adduct (trade name CORONATE L supplied by Nippon Polyurethane Industry Co., Ltd.), trimethylolpropane/hexamethylene diisocyanate adduct (trade name CORONATE HL supplied by Nippon Polyurethane Industry Co., Ltd.), trimethylolpropane/xylylene diisocyanate adduct (trade name TAKENATE 110N supplied by Mitsui Chemicals Inc.), and hexamethylene diisocyanate crosslinking agents (HDI crosslinking agents) (trade name DURANATE supplied by Asahi Kasei Chemicals Corporation).

Non-limiting examples of the epoxy crosslinking agents (multifunctional epoxides) include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, poly(ethylene glycol) diglycidyl ethers, poly(propylene glycol) diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl-tris(2-hydroxyethyl) isocyanurate, resorcinol diglycidyl ether, and bisphenol-S diglycidyl ether; as well as epoxy resins each containing two or more epoxy groups per molecule. The epoxy crosslinking agents may also be selected from commercial products such as trade name TETRAD C supplied by MITSUBISHI GAS CHEMICAL COMPANY, INC.

The crosslinking agent for use in the present invention is preferably blended so that the acrylic pressure-sensitive adhesive layer before curing via radiation irradiation has a gel fraction of preferably 10% to 70%, and more preferably 10% to 50%. The acrylic pressure-sensitive adhesive layer before radiation curing, if having a gel fraction less than 10%, may have lower processability; and, if having a gel fraction greater than 70%, may have lower wettability to an adherend upon application (lamination) and may have lower adhesive strength. The content of the crosslinking agent may vary depending on the molecular weight of the acrylic copolymer to be used, the contents of functional-group-containing monomers, and the type of the crosslinking agent. The content is generally about 0.1 to about 5 parts by mass, and preferably about 0.5 to about 3 parts by mass, per 100 parts by mass of the acrylic copolymer.

The radiation-curable pressure-sensitive adhesive composition in the present invention may contain a tackifier resin (tackifier). Non-limiting examples of the tackifier resin include rosin derivatives, polyterpenes, petroleum resins, and oil-soluble phenols. However, such tackifier resin, if used in a larger amount, may cause the acrylic pressure-sensitive adhesive layer to have a higher glass transition temperature and to have lower drop impact resistance. To eliminate or minimize this, the tackifier resin may be blended in an amount of about 5 to about 10 parts by mass per 100 parts by mass of the acrylic copolymer.

The radiation-curable pressure-sensitive adhesive composition in the present invention may further contain a silane coupling agent. When the acrylic pressure-sensitive adhesive layer is applied to a hydrophilic adherend such as glass, the presence of the silane coupling agent advantageously allows the acrylic pressure-sensitive adhesive layer to have better waterproofing at the interface with the adherend. The silane coupling agent may be blended in an amount of preferably 1 part by mass or less, more preferably 0.01 to 1 part by mass, and furthermore preferably 0.02 to 0.6 part by mass, per 100 parts by mass of the acrylic copolymer. The silane coupling agent, if blended in an excessively large amount, may cause the acrylic pressure-sensitive adhesive layer to have excessively high adhesive strength to the glass and to offer poor removability. The silane coupling agent, if blended in an excessively small amount, may cause the acrylic pressure-sensitive adhesive layer to have lower durability.

Examples of the silane coupling agent include, but are not limited to, epoxy-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino-containing silane coupling agents such as 3-aminopropyltrimethoxysilane, N-2-(aminoethyl)-3-aminopropylmethyldimethoxysilane, 3-triethoxysilyl-N-(1,3-dimethylbutylidene)propylamine, and N-phenyl-γ-aminopropyltrimethoxysilane; (meth)acryl-containing silane coupling agents such as 3-acryloxypropyltrimethoxysilane and 3-methacryloxypropyltriethoxysilane; and isocyanato-containing silane coupling agents such as 3-isocyanatopropyltriethoxysilane. The radiation-curable pressure-sensitive adhesive composition may contain each of different silane coupling agents alone or in combination.

In addition, the radiation-curable pressure-sensitive adhesive composition in the present invention may contain one or more other known additives. Non-limiting examples of the additives include colorants, pigments and other powdery substances, dyestuffs, surfactants, plasticizers, surface lubricants, leveling agents, softeners, antioxidants, age inhibitors, photostabilizers, polymerization inhibitors, inorganic or organic fillers, metal powders, particulate substances, and foil-like substances. The additives may be selected and added as appropriate according to the intended use. The amount of these additives may be decided as appropriate within such a range as not to adversely affect the advantageous effects of the present invention and is typically preferably 10 parts by mass or less per 100 parts by mass of the acrylic copolymer.

Acrylic Pressure-Sensitive Adhesive Layer

The acrylic pressure-sensitive adhesive layer in the present invention is formed from (derived from) the radiation-curable pressure-sensitive adhesive. The acrylic pressure-sensitive adhesive layer may have a thickness not limited, but typically preferably about 1 to about 300 μm, more preferably 10 to 200 μm, furthermore preferably 20 to 100 μm, and particularly preferably 30 to 70 μm.

The acrylic pressure-sensitive adhesive layer may be formed typically by applying the radiation-curable pressure-sensitive adhesive composition to a support, and heating and drying the applied composition to remove the polymerization solvent or another component from the composition. Upon application, the radiation-curable pressure-sensitive adhesive composition may be combined with one or more solvents as appropriate, where the solvents are other than the polymerization solvent.

The radiation-curable pressure-sensitive adhesive composition may be applied by any of various coating procedures. Specifically, non-limiting examples of the coating procedures include comma coating, roll coating, kiss-contact roll coating, gravure coating, reverse coating, roll brushing, spray coating, dip roll coating, bar coating, knife coating, air-knife coating, curtain coating, lip coating, and extrusion coating typically with a die coater.

The heating/drying is performed at a temperature of preferably 50° C. to 120° C. The heating, when performed at a temperature within the range, may give a pressure-sensitive adhesive layer having excellent adhesive properties (tack properties). The drying may be performed for a time selected as appropriate. The drying time is preferably 5 seconds to 20 minutes, more preferably 5 seconds to 10 minutes, and furthermore preferably 10 seconds to 5 minutes.

The support for use in the present invention, on which the acrylic pressure-sensitive adhesive layer is formed, may be selected from after-mentioned various substrates and may also be selected from release-treated sheets. Assume that the acrylic pressure-sensitive adhesive layer is formed using a release-treated sheet. In this case, the acrylic pressure-sensitive adhesive layer itself can be used as a so-called “substrate-less” double-sided pressure-sensitive adhesive transfer sheet for securing portable electronic device members, where the double-sided pressure-sensitive adhesive transfer sheet is devoid of substrates. The acrylic pressure-sensitive adhesive layer having the above configuration may also be applied to an appropriate substrate to give a double-sided pressure-sensitive adhesive sheet for securing portable electronic device members. The release-treated sheet is preferably selected from silicone release liners.

Assume that the pressure-sensitive adhesive layer is formed on the release-treated sheet to give a pressure-sensitive adhesive sheet. The pressure-sensitive adhesive layer in the pressure-sensitive adhesive sheet, when exposed, may be protected with a release-treated sheet (separator) before actual use. The release-treated sheet is removed upon actual use.

Non-limiting examples of constitutive materials for the separator include plastic films such as films of polyethylenes, polypropylenes, poly(ethylene terephthalate) s, and polyesters; porous materials such as paper, cloth, and nonwoven fabrics; as well as nets, foamed sheets, metallic foils, and laminates of them, and any other appropriate thin articles. Among them, plastic films are preferred for excellent surface smoothness.

The plastic films are not limited, as long as being films that can protect the pressure-sensitive adhesive layer, and are exemplified by polyethylene films, polypropylene films, polybutene films, polybutadiene films, polymethylpentene films, poly(vinyl chloride) films, vinyl chloride copolymer films, poly(ethylene terephthalate) films, poly(butylene terephthalate) films, polyurethane films, and ethylene-vinyl acetate copolymer films.

The separator has a thickness of generally preferably about 5 to about 200 μm, and more preferably about 5 to about 100 μm. The separator may be subjected to mold-release and antisoil treatment and/or antistatic treatment, as needed. The mold-release and antisoil treatment may be performed using a release agent or silica powder. Non-limiting examples of the release agent include silicone-, fluorine-, long-chain alkyl-, and fatty acid amide-release agents. The antistatic treatment may be performed typically via coating, kneading, or vapor deposition. In particular, a surface release treatment such as silicone treatment, long-chain alkyl treatment, or fluoridation performed as appropriate on the separator can allow the separator to have better releasability from the pressure-sensitive adhesive layer.

Double-Sided Pressure-Sensitive Adhesive Sheet for Securing Portable Electronic Device Members

The double-sided pressure-sensitive adhesive sheet according to the present invention for securing portable electronic device members includes the acrylic pressure-sensitive adhesive layer at at least one side thereof. For example, in an embodiment in configuration, the double-sided pressure-sensitive adhesive sheet may include an appropriate substrate, and the acrylic pressure-sensitive adhesive layer on or over both sides of the substrate. In another embodiment in configuration, the double-sided pressure-sensitive adhesive sheet may include the substrate, the acrylic pressure-sensitive adhesive layer on or over one side of the substrate, and another pressure-sensitive adhesive layer on or over the other side of the substrate, where the other pressure-sensitive adhesive layer differs in type and/or thickness from the acrylic pressure-sensitive adhesive layer. Accordingly, the radiation-curable pressure-sensitive adhesive composition may be applied onto the substrate to directly form the acrylic pressure-sensitive adhesive layer on the substrate; or, the acrylic pressure-sensitive adhesive layer may be disposed on the substrate by separately forming the acrylic pressure-sensitive adhesive layer on a separator, and applying the formed acrylic pressure-sensitive adhesive layer onto the substrate. In yet another embodiment in configuration, the acrylic pressure-sensitive adhesive layer itself may be used as a so-called “substrate-less” double-sided pressure-sensitive adhesive transfer sheet for securing portable electronic device members, where the double-sided pressure-sensitive adhesive transfer sheet is devoid of substrates.

As used herein, the term “pressure-sensitive adhesive sheet” also refers to and includes a “pressure-sensitive adhesive tape”. The double-sided pressure-sensitive adhesive sheet according to the present invention for securing portable electronic device members may also be a roll as wound.

The substrate is not limited and is exemplified by plastic films; porous materials such as paper, cloth, and nonwoven fabrics; nets, foamed sheets, metallic foils, and laminates of them, and any other appropriate thin articles, as with the constitutive materials for the separator. In particular, as is used in the double-sided pressure-sensitive adhesive sheet according to the present invention for securing portable electronic device members, the substrate is preferably selected from non-foaming thermoplastic films. Such non-foaming thermoplastic films are preferred for ensuring processability in the formation typically of a double-sided adhesive tape including a narrow portion with a width of 1 mm or less, or entirely having a width of 1 mm or less.

The thermoplastic film to constitute the substrate in the present invention preferably contains at least one resin selected from the group consisting of soft polyolefin resins, soft urethane resins, soft acrylic resins, soft polyester resins (e.g., poly(butylene terephthalate)s), and soft vinyl chloride resins. Non-limiting examples of the substrate include soft polyolefin resin sheets made of soft polyolefin resins; soft urethane resin sheets made of soft urethane resins; soft acrylic resin sheets made of soft acrylic resins; soft polyester resin sheets (soft polyester resin films) made of soft polyester resins; and soft vinyl chloride resin sheets made of soft vinyl chloride resins.

Specifically, non-limiting example of the thermoplastic film constituting the substrate include sheets of polyester resins such as poly(ethylene terephthalate)s and poly(butylene terephthalate)s; olefinic resin sheets prepared using, as starting materials, EMMA (ethylene-methyl methacrylate copolymer) resins or EVA (ethylene-vinyl acetate copolymer) resins; polyethylene resin sheets made of at least one selected typically from low-density polyethylenes, and linear low-density polyethylenes derived from components including an α-olefin component; polyolefin resin sheets made of at least one selected from olefinic polymers such as propylene polymers (homopolymers, block copolymers, and random copolymers), propylene polymers blended in-reactor with a rubber component, ethylene-propylene copolymers, propylene-α-olefin copolymers, and ethylene-propylene-α-olefin copolymers; and vinyl chloride resin sheets. The substrate may be made of two or more different resins as selected from the above-mentioned resins to constitute the resin sheets.

Materials for use in members of portable electronic devices often require the absence of halogen-containing substances. Accordingly, the substrate is preferably approximately devoid of halogens.

The substrate is preferably subjected to a surface processing via corona treatment and/or primer coating. This is preferred for better adhesion with the acrylic pressure-sensitive adhesive layer. The substrate may have a thickness of preferably 4 μm to 200 μm, and more preferably 10 μm to 100 μm.

In an embodiment, the substrate may be colored black. The double-sided pressure-sensitive adhesive sheet according to the present invention for securing portable electronic device members, when employing such a black-colored substrate, is usable in light shielding use. In this case, the substrate may have an L* (lightness) of preferably 35 or less (0 to 35), and more preferably 30 or less (0 to 30), where the lightness L* is specified in the L*a*b* color system. The a* and b* as specified in the L*a*b* color system can be individually selected as appropriate according to the L* value. The a* and b* preferably both fall within the range of −10 to 10, more preferably fall within the range of −5 to 5, furthermore preferably fall within the range of −2.5 to 2.5, and are most preferably both zero (0).

In the embodiment, the L*, a*, and b* as specified in the L*a*b* color system may be measured typically using a colorimeter (device name CR-200 supplied by Konica Minolta). The “L*a*b* color system” refers to a color space that is recommended by the International Commission on Illumination (CIE) in 1976 and is called “CIE 1976 (L*a*b*) color system”. The L*a*b* color system is prescribed by JIS Z 8781-4 in Japanese Industrial Standards.

Non-limiting examples of black colorants for use to color the substrate black include carbon black (e.g., furnace black, channel black, acetylene black, thermal black, and lamps black), graphite, copper oxide, manganese dioxide, aniline black, perylene black, black titanium oxide, cyanine black, activated carbon, ferrite (e.g., non-magnetic ferrite and magnetic ferrite), magnetite, chromium oxide, iron oxide, molybdenum disulfide, chromium complexes, complex oxide black dyes, and anthraquinone organic black dyes. Among them, carbon black is preferred from the viewpoint of cost and availability. Each of different black colorants may be used alone or in combination.

The amount of the black colorant(s) is not limited and may be such an amount as to impart desired optical properties to the double-sided pressure-sensitive adhesive sheet according to the embodiment for securing portable electronic device members. The coloring treatment of the substrate may be performed by a technique of adding a filler, a pigment, and/or any other substance to a thermoplastic film constituting the substrate to color the substrate, or by a technique of performing black printing on the thermoplastic film.

The double-sided pressure-sensitive adhesive sheet for securing portable electronic device members, when used in light-shielding use, may have a visible light transmittance of preferably 15% or less, more preferably 10% or less, furthermore preferably 5% or less, still more preferably 1% or less, and most preferably 0.1% or less. As used herein, the term “visible light transmittance” refers to a transmittance of light at a wavelength of 550 nm. Control of the visible light transmittance to 15% or less imparts good shielding properties to the double-sided pressure-sensitive adhesive sheet for securing portable electronic device members.

In another embodiment, the substrate may be colored white. The substrate, when colored white, allows the double-sided pressure-sensitive adhesive sheet for securing portable electronic device members to be used in light-reflecting use. In this embodiment, the substrate may preferably have an L* (lightness) of 87 or more (87 to 100), and more preferably 87 or more (87 to 100), where the lightness L* is specified in the L*a*b* color system. The a* and b* specified in the L*a*b* color system may be independently selected as appropriate according to the L* value. The a* and b* are both typically preferably in the range of −10 to 10, more preferably in the range of −5 to 5, furthermore preferably in the range of −2.5 to 2.5, and particularly preferably both zero (0).

Non-limiting examples of white colorants for use to color the substrate white include inorganic white colorants such as titanium oxides (titanium dioxides such as rutile titanium dioxide and anatase titanium dioxide), zinc oxide, aluminum oxide, silicon oxide, zirconium oxide, magnesium oxide, calcium oxide, tin oxide, barium oxide, cesium oxide, yttrium oxide, magnesium carbonate, calcium carbonates (e.g., precipitated calcium carbonate and heavy calcium carbonate), barium carbonate, zinc carbonate, aluminum hydroxide, calcium hydroxide, magnesium hydroxide, zinc hydroxide, aluminum silicate, magnesium silicate, calcium silicate, barium sulfate, calcium sulfate, barium stearate, zinc white, zinc sulfide, talc, silica, alumina, clay, kaolin, titanium phosphate, mica, gypsum, white carbon, diatomaceous earth, bentonite, lithopone, zeolite, sericite, and hydrated halloysite; and organic white colorants such as acrylic resin particles, polystyrene resin particles, polyurethane resin particles, amide resin particles, polycarbonate resin particles, silicone resin particles, urea-formalin resin particles, and melamine resin particles. Each of different white colorants may be used alone or in combination.

The amount of the white colorant is not limited and may be such an amount as to impart desired optical properties to the double-sided pressure-sensitive adhesive sheet according to the embodiment for securing portable electronic device members. The coloring treatment of the substrate may be performed by a technique of adding a filler, a pigment, or any other substance to a thermoplastic film constituting the substrate to color the substrate; or by a technique of performing white printing on the thermoplastic film.

The double-sided pressure-sensitive adhesive sheet for securing portable electronic device members, when used in light-reflecting use, may have a visible light reflectance of preferably 20% or more, more preferably 40% or more, and furthermore preferably 60% or more. As used herein, the term “visible light reflectance” refers to a reflectance of light at a wavelength of 550 nm. Control of the light reflectance to 20% or more gives good light reflectivity to the double-sided pressure-sensitive adhesive sheet.

In yet another embodiment, the substrate may be colored black in one principal surface and be colored white in the other principal surface. The substrate in this embodiment may be prepared typically by subjecting one principal surface of a black substrate to a white printing treatment, or subjecting one principal surface of a white substrate to a black printing treatment. Alternatively, the substrate may be prepared by subjecting one principal surface of a transparent substrate to a black printing treatment and subjecting the other principal surface to a white printing treatment.

The double-sided pressure-sensitive adhesive sheet according to the present invention for securing portable electronic device members may have a thickness of preferably 10 μm to 400 μm, more preferably 30 to 300 μm, furthermore preferably 40 to 200 μm, and particularly preferably 50 to 150 μm. The double-sided pressure-sensitive adhesive sheet, if having a thickness less than 10 μm, may hardly have bond strength and impact resistance both at satisfactory levels. In contrast, the double-sided pressure-sensitive adhesive sheet, if having a thickness greater than 400 μm, may be unsuitable in uses for securing thin-designed members.

Portable Electronic Device Production Method

The present invention provides a method for producing a portable electronic device. In the method, a portable electronic device member is held using the double-sided pressure-sensitive adhesive sheet for securing portable electronic device members, and radiation is then applied to the double-sided pressure-sensitive adhesive sheet to secure the member.

The portable electronic device for use in the present invention is not limited, but may be exemplified by cellular phones, smartphones, digital cameras, electronic organizers, portable music players, handheld game consoles, and tablet personal computers. Non-limiting examples of the portable electronic device member to be joined to such a portable electronic device include display panels to be disposed on image display modules; lenses; and LCD parts. The member is joined to a cabinet.

In the present invention, the portable electronic device member is secured via the double-sided pressure-sensitive adhesive sheet for securing portable electronic device members. For example, of a smartphone, a glass lens and a cabinet are joined to each other via the double-sided pressure-sensitive adhesive sheet for securing portable electronic device members. Radiation is then applied through the lens to cure the pressure-sensitive adhesive layer to thereby secure the member (lens).

Non-limiting examples of the radiation include ultraviolet rays, laser beams, alpha rays, beta rays, gamma rays, X rays, and electron beams. Among them, ultraviolet rays are preferably used in points of good controllability, good handleability, and cost. Of ultraviolet rays, an ultraviolet ray at a wavelength of 200 to 400 nm is more preferably used. Such an ultraviolet ray may be applied using an appropriate light source. Non-limiting examples of the light source include high-pressure mercury lamps, low-pressure mercury lamps, microwave-excited lamps, metal halide lamps, chemical lamps, black-light lamps, and LEDs. The ultraviolet ray may be applied at a dose (cumulative dose) of generally about 1000 mJ/cm² to about 10000 mJ/cm², and preferably about 2000 mJ/cm² to about 4000 mJ/cm².

Assume that the portable electronic device member is an entirely transparent glass lens. In this case, the radiation can be applied from above to the double-sided pressure-sensitive adhesive sheet. However, the edge of a certain member such as a screen-display glass lens of a portable electronic device is printed black or another color, and the tape is laminated on the printed portion. In this case, the radiation, when applied from above, may fail to reach the tape. To eliminate or minimize this, it is important to apply the radiation so that a light incident angle θ to a portion to be irradiated is 8° to 20° (see FIG. 4). The incident angle θ is more preferably 8° to 15°, and furthermore preferably 9° to 11°. The light, if applied at an incident angle θ of 20° or more, may fail to reach the inner part. The light, if applied at an incident angle θ of 8° or less, may be reflected to fail to reach the inner part, because most of applied energy is reflected.

The irradiation in such a manner that the incident angle θ is 8° to 20° may be performed while tilting a lamp, which emits radiation energy, with respect to the four sides to be irradiated, or while tilting the member to be irradiated with respect to the lamp. Alternatively, the irradiation may be performed by reflecting light applied from above to turn the light using a prism made of mirrors, as illustrated in FIG. 5. For example, the irradiation may be preformed by applying light from above, reflecting the applied light into a rectangular frame form using a prism as illustrated in FIG. 6 so that the incident angle θ is 8° to 20°. The irradiation may also be performed by preparing a prism having smaller dimensions as compared with the frame to be irradiated, where the prism has an angle α of 49° to 55°. The angle α is preferably 49° to 52.5°, and more preferably 49.5° to 50.5°. The lengths of individual sides of the prism may be adjusted so that light reflected toward the four sides of the frame to be irradiated are applied each at a predetermined angle.

Assume that the radiation is applied to the double-sided pressure-sensitive adhesive sheet after application (lamination) by the above-mentioned method so that the incident angle θ is 8° to 20°. In this case, 18% to 40% of the light is reflected at the interface between the air space and the glass to lose irradiation energy. In consideration of the reflection, the radiation is preferably applied in a larger cumulative dose than the predetermined cumulative dose by 18% to 40%.

### EXAMPLES

The present invention will be illustrated in further detail with reference to several examples below. It should be noted, however, that the examples are by no means intended to limit the scope of the present invention.

Pressure-Sensitive Adhesive Composition 1

In a reactor (flask) equipped with a stirrer, a circulation condenser, a thermometer, a dropper, and a nitrogen inlet tube, 5 parts by mass of acrylic acid (AA), 95 parts by mass of 2-ethylhexyl acrylate (2EHA), and 160 parts by mass of ethyl acetate polymerization solvent were charged, followed by stirring for 2 hours with introduction of nitrogen gas.

After oxygen was removed from the polymerization system, the mixture was combined with 0.2 part by mass of 2,2′-azobisisobutyronitrile (AIBN), raised in temperature to 60° C., and subjected to a polymerization reaction for 6 hours. After the reaction was stopped, the reaction mixture was combined with 53 parts by mass of ethyl acetate and yielded a polymer solution containing a polymer (adjusted pressure-sensitive adhesive solution). The polymer solution had a polymer solids concentration of 32.0% (in weight percent) and had a weight-average molecular weight of the polymer of 110×10⁴.

The polymer solution was combined with, per 100 parts by mass of the polymer in the polymer solution, 15 parts by mass of a multifunctional urethane acrylate (trade name SHIKOH UV-7650B, supplied by Nippon Synthetic Chemical Industry Co., Ltd., having a weight-average molecular weight of 2300, a number of functional groups of 4 to 5, and a solids content of 99%) as a multifunctional acrylic oligomer, and 0.8 part by mass of trade name IRGACURE 184 (supplied by BASF Japan Ltd.) as a photoinitiator. The resulting mixture was further combined with, per 100 parts by mass of the polymer in the polymer solution, 1.0 part by mass of an aromatic polyisocyanate (trade name CORONATE L, supplied by Nippon Polyurethane Industry Co., Ltd., having a solids content of 75%) as a crosslinking agent, diluted with ethyl acetate to a solids concentration of 27.0%, thoroughly stirred, and yielded a radiation-curable pressure-sensitive adhesive composition (solvent-borne pressure-sensitive adhesive).

This radiation-curable pressure-sensitive adhesive composition was defined as a “pressure-sensitive adhesive composition 1”.

Pressure-Sensitive Adhesive Composition 2

A radiation-curable pressure-sensitive adhesive composition (solvent-borne pressure-sensitive adhesive) was prepared by a procedure similar to that in the pressure-sensitive adhesive composition 1, except for using, per 100 parts by mass of the polymer in the polymer solution, 20 parts by mass of the multifunctional urethane acrylate (trade name SHIKOH UV-7650B, supplied by Nippon Synthetic Chemical Industry Co., Ltd.) as the multifunctional acrylic oligomer.

This radiation-curable pressure-sensitive adhesive composition was defined as a “pressure-sensitive adhesive composition 2”.

Pressure-Sensitive Adhesive Composition 3

A radiation-curable pressure-sensitive adhesive composition (solvent-borne pressure-sensitive adhesive) was prepared by a procedure similar to that in the pressure-sensitive adhesive composition 1, except for using 5 parts by mass of dimethylaminopropylmethacrylamide (trade name DMAPMA, supplied by Evonik Japan Co., Ltd.) as a basic monomer instead of the multifunctional urethane acrylate (trade name SHIKOH UV-7650B, supplied by Nippon Synthetic Chemical Industry Co., Ltd.) as a multifunctional oligomer.

This radiation-curable pressure-sensitive adhesive composition was defined as a “pressure-sensitive adhesive composition 3”.

Pressure-Sensitive Adhesive Composition 4

A radiation-curable pressure-sensitive adhesive composition (solvent-borne pressure-sensitive adhesive) was prepared by a procedure similar to that in the pressure-sensitive adhesive composition 1, except for using 10 parts by mass of a basic monomer (trade name DMAPMA, supplied by Evonik Japan Co., Ltd.) instead of the multifunctional urethane acrylate (trade name SHIKOH UV-7650B, supplied by Nippon Synthetic Chemical Industry Co., Ltd.) as a multifunctional oligomer.

This radiation-curable pressure-sensitive adhesive composition was defined as a “pressure-sensitive adhesive composition 4”.

Pressure-Sensitive Adhesive Composition 5

A radiation-curable pressure-sensitive adhesive composition (solvent-borne pressure-sensitive adhesive) was prepared by a procedure similar to that in the pressure-sensitive adhesive composition 1, except for using, per 100 parts by mass of the polymer in the polymer solution, 10 parts by mass of the multifunctional urethane acrylate (trade name SHIKOH UV-7650B, supplied by Nippon Synthetic Chemical Industry Co., Ltd.) as a multifunctional acrylic oligomer; and further using 5 parts by mass of a basic monomer (trade name DMAPMA, supplied by Evonik Japan Co., Ltd.).

This radiation-curable pressure-sensitive adhesive composition was defined as a “pressure-sensitive adhesive composition 5”.

Pressure-Sensitive Adhesive Composition 6

Into a four-necked flask equipped with impellers, a thermometer, a nitrogen gas inlet tube, and a condenser, 63 parts by mass of 2-ethylhexyl acrylate (2EHA), 15 parts by mass of N-vinylpyrrolidone (NVP), 9 parts by mass of methyl methacrylate (MMA), 13 parts by mass of 2-hydroxyethyl acrylate (HEA), and, as a thermal initiator, 0.2 part by mass of 2,2′-azobisisobutyronitrile (AIBN) together with 177.8 parts by mass of ethyl acetate were charged. The mixture was stirred at 23° C. in a nitrogen atmosphere for 2 hours, followed by a reaction at 65° C. for 5 hours and a subsequent reaction at 70° C. for 2 hours, and yielded a polymer solution containing a polymer (adjusted pressure-sensitive adhesive solution). The polymer solution had a polymer solids concentration of 36.0% (in weight percent) and had a weight-average molecular weight of the polymer of 85×10⁴.

The polymer solution was combined with, per 100 parts by mass of the polymer in the polymer solution, 10 parts by mass of a polyester diacrylate (trade name ARONIX M-6250, having a number of functional groups of 2, supplied by Toagosei Co. Ltd.) as a multifunctional oligomer and 0.8 part by mass of trade name IRGACURE 184 (supplied by BASF Japan Ltd.) as a photoinitiator. The resulting mixture was further combined with, per 100 parts by mass of the polymer in the polymer solution, 0.2 part by mass of an aromatic polyisocyanate (trade name TAKENATE D-110N, supplied by Mitsui Chemicals Inc., having a solids content of 75%) as a crosslinking agent and 0.3 part by mass of 3-glycidoxypropyltrimethoxysilane (trade name KBM403, supplied by Shin-Etsu Chemical Co., Ltd.) as a silane coupling agent, diluted with ethyl acetate to a solids concentration of 35.0%, thoroughly stirred, and yielded a radiation-curable pressure-sensitive adhesive composition (solvent-borne pressure-sensitive adhesive).

This radiation-curable pressure-sensitive adhesive composition was defined as a “pressure-sensitive adhesive composition 6”.

Pressure-Sensitive Adhesive Composition 7

A radiation-curable pressure-sensitive adhesive composition (solvent-borne pressure-sensitive adhesive) was prepared by a procedure similar to that in the pressure-sensitive adhesive composition 6, except for using 10 parts by mass of a multifunctional urethane acrylate (trade name SHIKOH UV-7650B, supplied by Nippon Synthetic Chemical Industry Co., Ltd.) as a multifunctional oligomer instead of the polyester diacrylate (trade name ARONIX M-6250, supplied by Toagosei Co. Ltd.).

This radiation-curable pressure-sensitive adhesive composition was defined as a “pressure-sensitive adhesive composition 7”.

Pressure-Sensitive Adhesive Composition 8

A radiation-curable pressure-sensitive adhesive composition (solvent-borne pressure-sensitive adhesive) was prepared by a procedure similar to that in the pressure-sensitive adhesive composition 6, except for using 10 parts by mass of a multifunctional urethane acrylate (trade name SHIKOH UV-7650B, supplied by Nippon Synthetic Chemical Industry Co., Ltd.) as a multifunctional oligomer instead of the polyester diacrylate (trade name ARONIX M-6250, supplied by Toagosei Co. Ltd.), and further using 10 parts by mass of a hydrogenated rosin ester (trade name PINECRYSTAL KE-100, supplied by Arakawa Chemical Industries, Ltd.) as a tackifier resin.

This radiation-curable pressure-sensitive adhesive composition was defined as a “pressure-sensitive adhesive composition 8”.

Pressure-Sensitive Adhesive Composition 9

Into a reactor (flask) equipped with a stirrer, a circulation condenser, a thermometer, a dropper, and a nitrogen inlet tube, 2.9 parts by mass of acrylic acid (AA), 5 parts by mass of vinyl acetate (VAc), 92 parts by mass of butyl acrylate (BA), 0.1 part by mass of hydroxyethyl acrylate (HEA), and, as polymerization solvents, 30 parts by mass of ethyl acetate and 120 parts by mass of toluene were charged, followed by stirring for 2 hours with introduction of nitrogen gas.

After oxygen was removed from the polymerization system, the mixture was combined with 0.2 part by mass of 2,2′-azobisisobutyronitrile (AIBN), raised in temperature to 60° C., and subjected to a polymerization reaction for 6 hours. This yielded a polymer solution containing a polymer (adjusted pressure-sensitive adhesive solution). The polymer solution had a polymer solids concentration of 40.0% (in weight percent) and had a weight-average molecular weight of the polymer of 50×10⁴.

The polymer solution was combined with, per 100 parts by mass of the polymer in the polymer solution, 4 parts by mass of a rosin resin (trade name PENSEL D-125, supplied by Arakawa Chemical Industries, Ltd., having a solids content of 100%), 4 parts by mass of a rosin resin (trade name SUPER ESTER A-100, supplied by Arakawa Chemical Industries, Ltd., having a solids content of 100%), 2 parts by mass of a rosin resin (trade name Foralyn 8020F, supplied by Eastman Chemical Company, having a solids content of 100%), and 6 parts by mass of terpene phenol resin (trade name TAMANOL 803L, supplied by Arakawa Chemical Industries, Ltd., having a solids content of 100%), and the mixture was thoroughly stirred until dissolved. After the stirring, the mixture was further combined with, per 100 parts by mass of the polymer in the polymer solution, 1.1 parts by mass of an aromatic polyisocyanate (trade name CORONATE L, supplied by Nippon Polyurethane Industry Co., Ltd., having a solids content of 75%) as a crosslinking agent, thoroughly stirred, and yielded a solvent-borne pressure-sensitive adhesive composition (solvent-borne pressure-sensitive adhesive).

This solvent-borne pressure-sensitive adhesive composition was defined as a “pressure-sensitive adhesive composition 9”.

Pressure-Sensitive Adhesive Composition 10

A radiation-curable pressure-sensitive adhesive composition (solvent-borne pressure-sensitive adhesive) was prepared by a procedure similar to that in the pressure-sensitive adhesive composition 1, except for using 15 parts by mass of a multifunctional urethane acrylate (trade name UA-510H, supplied by Kyoeisha Chemical Co., Ltd.) as a multifunctional oligomer instead of the multifunctional urethane acrylate (trade name SHIKOH UV-7650B, supplied by Nippon Synthetic Chemical Industry Co., Ltd.), and using 0.4 part by mass of the trade name IRGACURE 184 (supplied by BASF Japan Ltd.) and 0.4 part by mass of trade name IRGACURE 819 (supplied by BASF Japan Ltd.) both as photoinitiators.

This radiation-curable pressure-sensitive adhesive composition was defined as a “pressure-sensitive adhesive composition 10”.

Table 1 as follows provides a summary of formulations of the individual pressure-sensitive adhesive compositions.

TABLE 1

| | | Pressure- | Pressure- | Pressure- | Pressure- | Pressure- |
|---|---|---|---|---|---|---|
| | | sensitive | sensitive | sensitive | sensitive | sensitive |
| | | adhesive | adhesive | adhesive | adhesive | adhesive |
| | | composition 1 | composition 2 | composition 3 | composition 4 | composition 5 |
| Acrylic copolymer | 2EHA | 95 | 95 | 95 | 95 | 95 |
| | BA | | | | | |
| | MMA | | | | | |
| | NVP | | | | | |
| | VAc | | | | | |
| | AA | 5 | 5 | 5 | 5 | 5 |
| | HEA | | | | | |
| | Weight-average | 110 × 10⁴ | 110 × 10⁴ | 110 × 10⁴ | 110 × 10⁴ | 110 × 10⁴ |
| | molecular | | | | | |
| | weight | | | | | |
| Tackifier resin | KE-100 | | | | | |
| | D-125 | | | | | |
| | A-100 | | | | | |
| | 8020F | | | | | |
| | 803L | | | | | |
| Multifunctional | UV-7650B | 15 | 20 | | | 10 |
| acrylic oligomer | UA-510H | | | | | |
| | M-6250 | | | | | |
| Basic monomer | DMAPMA | | | 5 | 10 | 5 |
| Photoinitiator | Irgacure.184 | 0.8 | 0.8 | 0.8 | 0.8 | 0.8 |
| | Irgacure.819 | | | | | |
| Cross-linking | CORONATE L | 1 | 1 | 1 | 1 | 1 |
| agent | TAKENATE D- | | | | | |
| | 110N | | | | | |
| Silane coupling | KBM-403 | | | | | |
| agent | | | | | | |
| | | | | | | Pressure- |
| | | Pressure- | Pressure- | Pressure- | Pressure- | sensitive |
| | | sensitive | sensitive | sensitive | sensitive | adhesive |
| | | adhesive | adhesive | adhesive | adhesive | composition |
| | | composition 6 | composition 7 | composition 8 | composition 9 | 10 |
| Acrylic copolymer | 2EHA | 63 | 63 | 63 | | 95 |
| | BA | | | | 92 | |
| | MMA | 9 | 9 | 9 | | |
| | NVP | 15 | 15 | 15 | | |
| | VAc | | | | 5 | |
| | AA | | | | 2.9 | 5 |
| | HEA | 13 | 13 | 13 | 0.1 | |
| | Weight-average | 85 × 10⁴ | 85 × 10⁴ | 85 × 10⁴ | 50 × 10⁴ | 110 × 10⁴ |
| | molecular | | | | | |
| | weight | | | | | |
| Tackifier resin | KE-100 | | | 10 | | |
| | D-125 | | | | 4 | |
| | A-100 | | | | 4 | |
| | 8020F | | | | 2 | |
| | 803L | | | | 6 | |
| Multifunctional | UV-7650B | | 10 | 10 | | |
| acrylic oligomer | UA-510H | | | | | 15 |
| | M-6250 | 10 | | | | |
| Basic monomer | DMAPMA | | | | | |
| Photoinitiator | Irgacure.184 | 0.8 | 0.8 | 0.8 | | 0.4 |
| | Irgacure.819 | | | | | 0.4 |
| Cross-linking | CORONATE L | | | | 1.1 | |
| agent | TAKENATE D- | 0.2 | 0.2 | 0.2 | | |
| | 110N | | | | | |
| Silane coupling | KBM-403 | 0.3 | 0.3 | 0.3 | | |
| agent | | | | | | |

### Example 1

The pressure-sensitive adhesive composition 1 was applied onto a silicone-treated surface of a 38-μm poly(ethylene terephthalate) separator (trade name MRF38, supplied by Mitsubishi Polyester Film Inc.) so as to give a pressure-sensitive adhesive layer having a thickness after drying (dried coating thickness) of 49 μm. Thus, a coating layer was obtained. Next, the coating layer was dried at 100° C. for 2 minutes to form the pressure-sensitive adhesive layer and to give a process pressure-sensitive adhesive sheet. The pressure-sensitive adhesive sheet had a multilayer structure including the separator and the pressure-sensitive adhesive layer disposed on each other. The process pressure-sensitive adhesive sheet was prepared in a total number of 2.

A substrate was applied onto the pressure-sensitive adhesive layer of one of the process pressure-sensitive adhesive sheets. The substrate was a polyester film substrate (PET substrate), trade name LUMIRROR S10 #12, supplied by Toray Industries Inc., and had a thickness of 12 μm. Thus, a substrate-carried single-sided pressure-sensitive adhesive sheet was obtained. This had a multilayer structure including the separator, the pressure-sensitive adhesive layer, and the substrate disposed in this order.

The pressure-sensitive adhesive layer side of the other process pressure-sensitive adhesive sheet was applied to the substrate side of the substrate-carried single-sided pressure-sensitive adhesive sheet and yielded a double-sided pressure-sensitive adhesive sheet according to Example 1. The double-sided pressure-sensitive adhesive sheet had a total thickness of 110 μm and had a multilayer structure including the separator, the pressure-sensitive adhesive layer, the substrate, the pressure-sensitive adhesive layer, and the separator disposed in this order.

The double-sided pressure-sensitive adhesive sheet, when subjected to evaluations and measurements as follows, was left stand at an ambient temperature of 50° C. for 24 hours within a light-shielding sheet so as to block light, before the evaluations and the measurements.

### Example 2

A double-sided pressure-sensitive adhesive sheet was prepared by a procedure similar to that in Example 1, except for using the pressure-sensitive adhesive composition 2, instead of the pressure-sensitive adhesive composition 1.

### Example 3

A double-sided pressure-sensitive adhesive sheet was prepared by a procedure similar to that in Example 1, except for using the pressure-sensitive adhesive composition 3, instead of the pressure-sensitive adhesive composition 1.

### Example 4

A double-sided pressure-sensitive adhesive sheet was prepared by a procedure similar to that in Example 1, except for using the pressure-sensitive adhesive composition 4, instead of the pressure-sensitive adhesive composition 1.

### Example 5

A double-sided pressure-sensitive adhesive sheet was prepared by a procedure similar to that in Example 1, except for using the pressure-sensitive adhesive composition 5, instead of the pressure-sensitive adhesive composition 1.

### Example 6

A double-sided pressure-sensitive adhesive sheet was prepared by a procedure similar to that in Example 1, except for using the pressure-sensitive adhesive composition 10, instead of the pressure-sensitive adhesive composition 1.

### Comparative Example 1

A double-sided pressure-sensitive adhesive sheet was prepared by a procedure similar to that in Example 1, except for using the pressure-sensitive adhesive composition 6, instead of the pressure-sensitive adhesive composition 1.

### Comparative Example 2

A double-sided pressure-sensitive adhesive sheet was prepared by a procedure similar to that in Example 1, except for using the pressure-sensitive adhesive composition 7, instead of the pressure-sensitive adhesive composition 1.

### Comparative Example 3

A double-sided pressure-sensitive adhesive sheet was prepared by a procedure similar to that in Example 1, except for using the pressure-sensitive adhesive composition 8, instead of the pressure-sensitive adhesive composition 1.

### Comparative Example 4

A double-sided pressure-sensitive adhesive sheet was prepared by a procedure similar to that in Example 1, except for using the pressure-sensitive adhesive composition 9, instead of the pressure-sensitive adhesive composition 1.

Evaluations

The double-sided pressure-sensitive adhesive sheets prepared in the examples and the comparative examples were each subjected to measurements and evaluations as follows. The measurements results and the evaluations are shown in Table 2.

Weight-Average Molecular Weight

The weight-average molecular weight of each of the prepared polymers was measured by gel permeation chromatography (GPC). The polymer to be tested was dissolved in tetrahydrofuran to give a 0.1% by mass solution, the solution was left stand overnight, filtrated through a 0.45-μm membrane filter to give a filtrate, and the filtrate was used as a sample.

Analyzer: HLC-8120GPC, supplied by Tosoh Corporation

Column: TSK gel GMH-H(S)

Column size: 7.8 mm in diameter by 30 cm

Eluent: tetrahydrofuran (concentration: 0.1% by mass)

Flow rate: 0.5 ml/min

Detector: differential refractometer (RI)

Column temperature: 40° C.

Injection volume: 100 μl

Reference standard: polystyrene

Glass Transition Temperature

Plies of the pressure-sensitive adhesive layer formed on the separator in the process pressure-sensitive adhesive sheet were stacked to give a multilayer assembly (multilayered pressure-sensitive adhesive layer) having a thickness of about 2.3 mm. The multilayer assembly was irradiated to be cured, at an irradiance of 300 mW/cm² to a cumulative dose of 3000 mJ/cm² using a metal halide lamp (M3000L/22, supplied by TOSHIBA CORPORATION). The cured multilayer assembly was used as a measurement sample.

The glass transition temperature was measured in the following manner. Specifically, measurement was performed to plot a loss modulus using Rheometric Dynamic Viscoelastic Measurement System “ARES” with a parallel-plate jig having a diameter of 7.9 mm, at a frequency of 1 Hz and a rate of temperature rise of 5° C./min. The temperature at the peak point of the plotted loss modulus was defined as the glass transition temperature.

Storage Modulus

Plies of the pressure-sensitive adhesive layer formed on the separator in the process pressure-sensitive adhesive sheet were stacked to give a multilayer assembly (multilayered pressure-sensitive adhesive layer) having a thickness of about 2.3 mm. The multilayer assembly was irradiated to be cured, at an irradiance of 300 mW/cm² to a cumulative dose of 3000 mJ/cm² using a metal halide lamp (M3000L/22, supplied by TOSHIBA CORPORATION). The cured multilayer assembly was used as a measurement sample.

The storage modulus was determined in the following manner. Specifically, measurement was performed using Rheometric Dynamic Viscoelastic Measurement System “ARES” with a parallel-plate jig having a diameter of 7.9 mm, at a frequency of 1 Hz and a rate of temperature rise of 5° C./min. Based on the measurement, a storage shear modulus at 70° C. was calculated as the storage modulus.

Haze Measurement

A haze measurement sample was prepared in the following manner. A pressure-sensitive adhesive layer having a thickness of 49 μm was formed on a poly(ethylene terephthalate) separator by a procedure similar to that in the process pressure-sensitive adhesive sheet in Example 1. After drying, the pressure-sensitive adhesive layer surface of the resulting article was stacked on a 38-μm thick poly(ethylene terephthalate) separator (trade name MRE38, supplied by Mitsubishi Polyester Film Inc.) to give a double-sided pressure-sensitive adhesive transfer tape without substrate. This double-sided pressure-sensitive adhesive transfer tape was used as the haze measurement sample.

The haze was measured before and after curing by ultraviolet irradiation. Specifically, the measurement sample was irradiated with, and cured by, an ultraviolet ray from the MRE38 side using a metal halide lamp (M3000L/22, supplied by TOSHIBA CORPORATION) at an irradiance of 300 mW/cm² to a cumulative dose of 3000 mJ/cm². This was defined as the measurement sample after curing. The measurement was performed using a measuring instrument HAZE METER HM-150 supplied by Murakami Color Research Laboratory.

Push Out Force

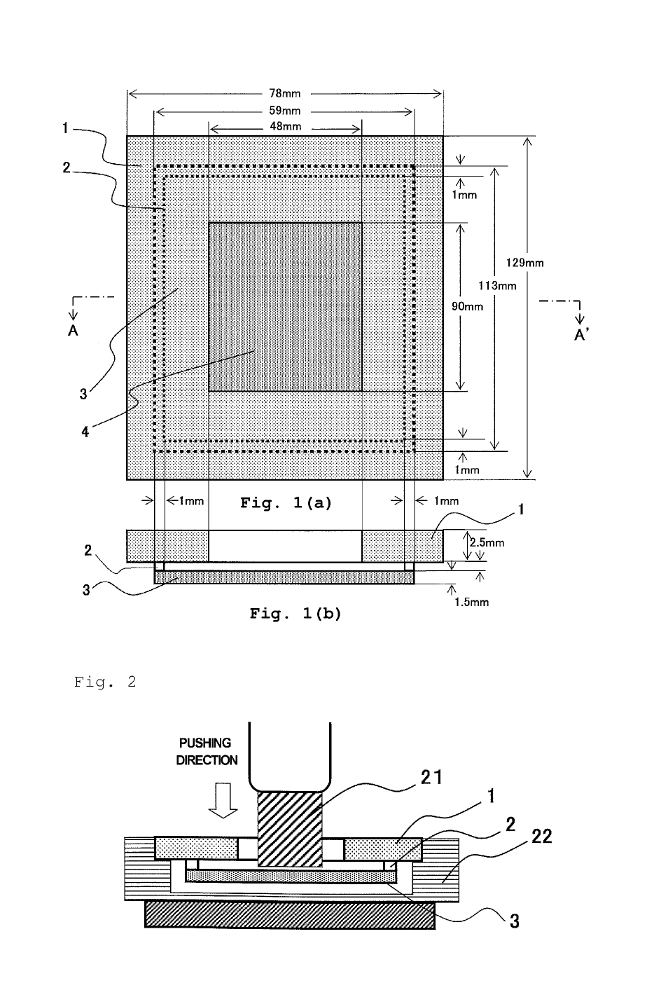

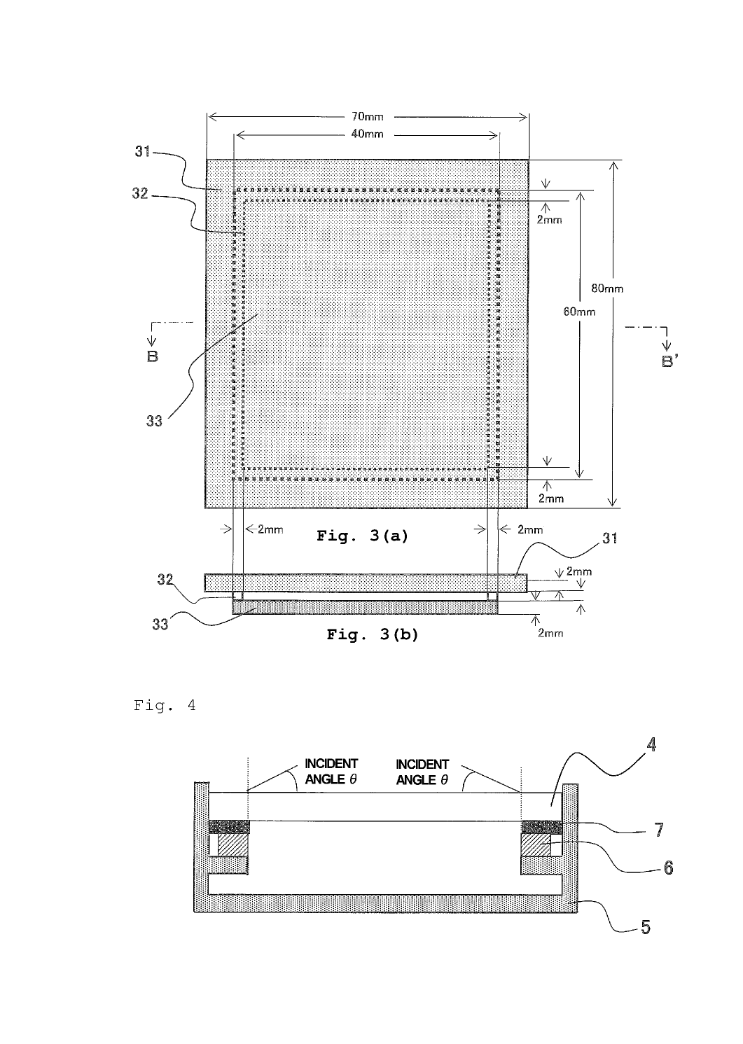

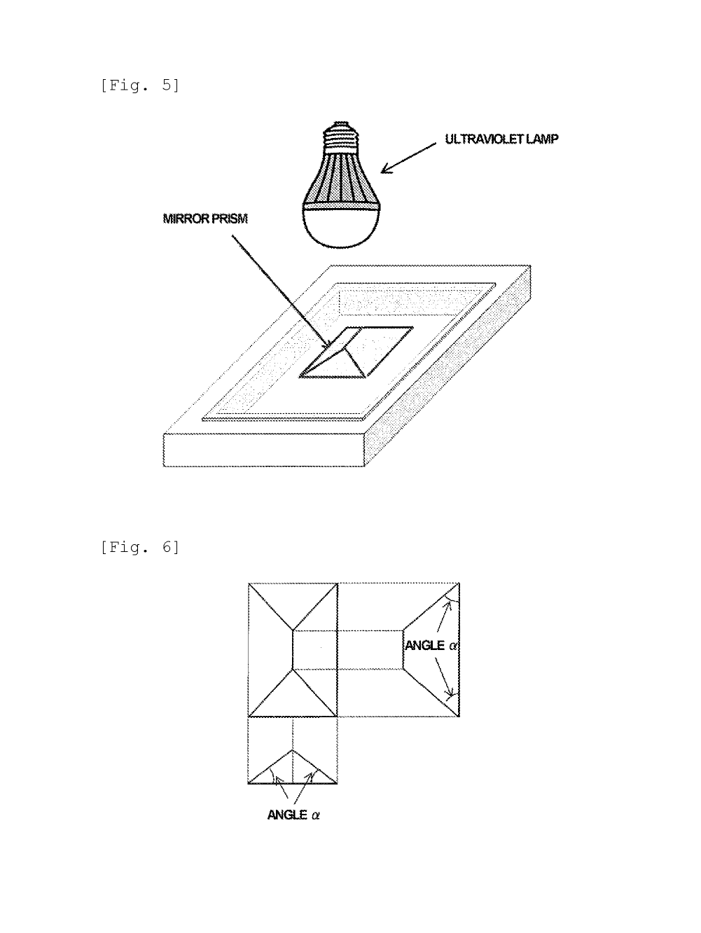

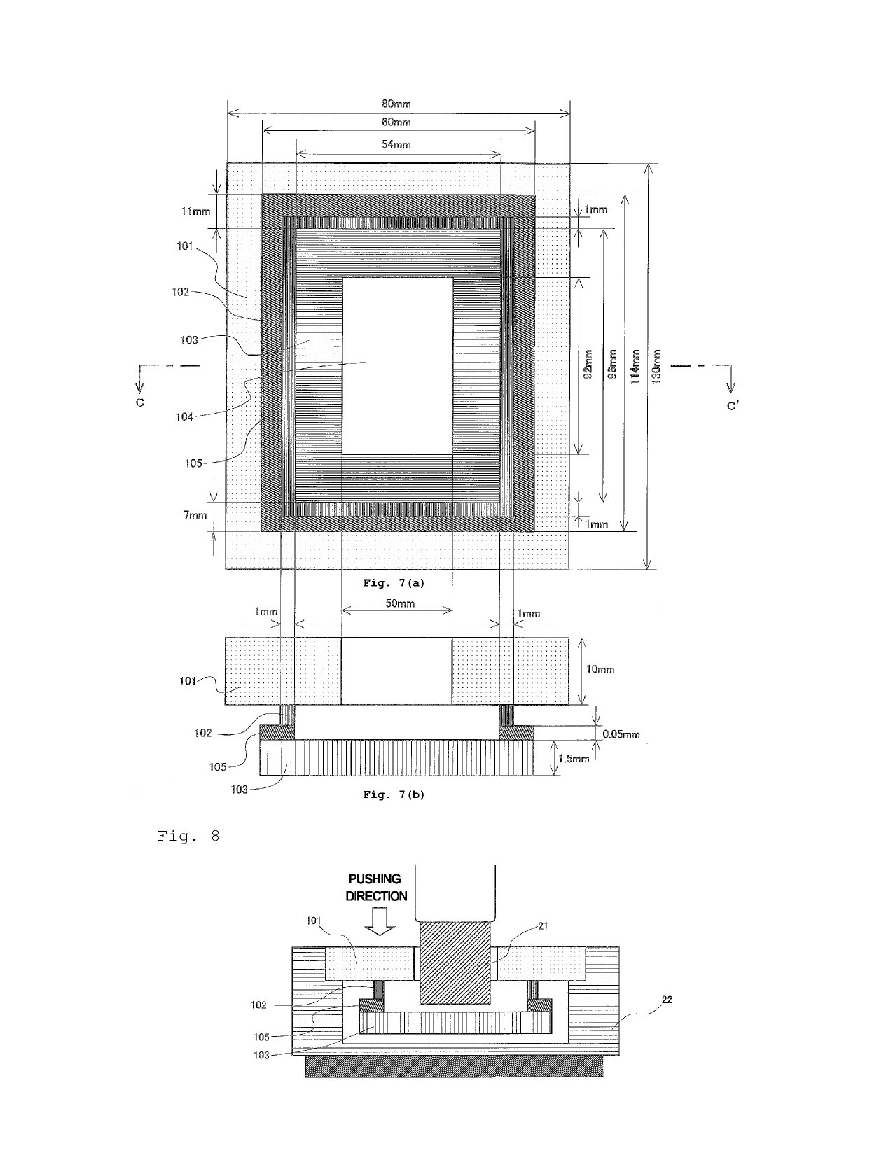

The double-sided pressure-sensitive adhesive sheet was cut into a frame-like piece having a size of 59 mm wide by 113 mm long by 1 mm frame-wide as illustrated in FIG. 1. This was used as a frame-like double-sided pressure-sensitive adhesive sheet 2. Via the frame-like double-sided pressure-sensitive adhesive sheet 2, a glass plate 3 and a stainless steel plate (SUS plate) 1 were laminated on each other by compression bonding via one reciprocating movement of a 5-kg roller and yielded an evaluation sample. The glass plate 3 had a size of 59 mm wide by 113 mm long by 1.5 mm thick. As the glass plate 3, Gorilla Glass supplied by Corning Inc. was used (hereinafter the same). The stainless steel plate 1 had a size of 78 mm wide by 129 mm long by 2.5 mm thick and had a through hole 4 at the center part, where the through hole had a size of 48 mm by 90 mm. Twelve (12) hours after the lamination, the resulting article was irradiated, to be cured, with an ultraviolet ray from the glass side using a metal halide lamp (M3000L/22, supplied by TOSHIBA CORPORATION) at an irradiance of 300 mW/cm² to a cumulative dose of 3000 mJ/cm². The article was left stand at an ambient temperature of 23° C. and relative humidity of 50% for 12 hours after the irradiation, and then subjected to a measurement. The sample according to Comparative Example 4, which is not a radiation-curable double-sided pressure-sensitive adhesive tape, was left stand at an ambient temperature of 23° C. and relative humidity of 50% for 24 hours after the lamination and then subjected to a measurement.

FIGS. 1(a) and 1(b) are a schematic top view and a schematic cross-sectional view taken along the line A-A′, respectively, of the evaluation sample. FIG. 1 illustrates the SUS plate 1, the frame-like double-sided pressure-sensitive adhesive sheet 2, the glass plate 3, and the through hole 4 provided in the SUS plate 1.

Each of the prepared evaluation samples was placed in the universal tensile compression testing machine. A pushing jig 21 shown in the figure and having an area of 39.6 cm² (45 mm by 88 mm) was allowed to pass through the through hole 4 in the SUS plate 1 and to descend at a speed of 10 mm/min. Thus, the glass plate 3 was pushed out to such a direction as to be away from the SUS plate 1. A maximum stress observed until the glass plate 3 and the SUS plate 1 were separated from each other was measured, and this was defined as the push out force. The measurement was performed at an ambient temperature of 23° C. and relative humidity of 50%.

FIG. 2 is a cross-sectional diagram illustrating how to measure the push out force. FIG. 2 illustrates the SUS plate 1, the frame-like double-sided pressure-sensitive adhesive sheet 2, the glass plate 3, the pushing jig 21, and a support 22. The evaluation sample was secured to the support 22 of the tensile compression testing machine as illustrated in FIG. 2, and the glass plate 3 of the evaluation sample was push out by the pushing jig 21 passed through the through hole 4 in the SUS plate 1. In the push out force measurement, the SUS plate 1 neither warped nor broke due to the load applied by the glass plate 3 as pushed out by the pushing jig 21.

Push Out Force (405-LED irradiation)

A measurement was performed by a procedure similar to that in the push out force evaluation method, except for irradiating and curing the article at an irradiance of 75 mW/cm² (measurement wavelength region: 395 to 445 nm) to a cumulative dose of 3000 mJ/cm² (measurement wavelength region: 395 to 445 nm) using, instead of the metal halide lamp, a 405-nm LED lamp (trade name H-12LH4-V3-1S11-SM2, supplied by HOYA CANDEO OPTRONICS CORPORATION).

Drop Impact Test

Each double-sided pressure-sensitive adhesive sheet was cut into a frame-like piece having a size of 40 mm wide by 60 mm long by 2 mm frame-wide as illustrated in FIG. 3, and this was used as a frame-like double-sided pressure-sensitive adhesive sheet 32. Via the frame-like double-sided pressure-sensitive adhesive sheet, an acrylic plate 33 and a polycarbonate plate 31 were laminated on each other by compression bonding via one reciprocating movement of a 5-kg roller and yielded an evaluation sample. The acrylic plate 33 had a size of 43 mm wide by 63 mm long by 2 mm thick. The polycarbonate plate 31 had a size of 70 mm wide by 80 mm long by 2 mm thick. Twelve (12) hours after the lamination, the resulting article was irradiated, to be cured, with an ultraviolet ray from the acrylic plate side at an irradiance of 300 mW/cm² to a cumulative dose of 3000 mJ/cm² using a metal halide lamp (M3000L/22, supplied by TOSHIBA CORPORATION). The article was left stand at an ambient temperature of 23° C. and relative humidity of 50% for 12 hours after the irradiation, and then subjected to a measurement. The sample according to Comparative Example 4, which is not a radiation-curable double-sided pressure-sensitive adhesive tape, was left stand at an ambient temperature of 23° C. and relative humidity of 50% for 24 hours after the lamination, and then subjected to the measurement.

A weight was attached to the backside of the polycarbonate plate 31 in each of the evaluation samples so as to give a total weight of 220 g. The weighted evaluation sample was subjected to a drop test in which the weighted evaluation sample was freely dropped 60 times from a height of 1.2 m to a concrete plate at room temperature (about 23° C.). The dropping direction was adjusted so that the acrylic plate 33 surface of the evaluation sample faced downward.

In every drop, whether the bonding (joining) between the acrylic plate and the polycarbonate plate was maintained was visually determined. The number of drops until the acrylic plate and the polycarbonate plate were separated from each other was evaluated as drop impact resistance at room temperature. When a sample did not undergo separation even after 60 drops, the drop impact resistance is indicated as “60 or more” or “>60”.

TABLE 2

| | | Exam- | Exam- | Exam- | Exam- | Exam- | | | | | |
|---|---|---|---|---|---|---|---|---|---|---|---|
| | | ple 1 | ple 2 | ple 3 | ple 4 | ple 5 | Example 6 | Com. Ex. 1 | Com. Ex. 2 | Com. Ex. 3 | Com. Ex. 4 |
| Glass transition | ° C. | −49 | −49 | −45 | −43 | −43 | −47.7 | −17 | 3 | 4 | −33 |
| temperature | | | | | | | | | | | |
| Storage modulus | Pa | 7.3 × | 16.8 × | 11.4 × | 16.0 × | 19.8 × | 8.6 × 10⁴ | 7.0 × 10⁴ | 26.4 × 10⁴ | 13.0 × 10⁴ | 3.1 × 10⁴ |
| (70° C.) | | 10⁴ | 10⁴ | 10⁴ | 10⁴ | 10⁴ | | | | | |
| Haze | Before | 29.0 | 33.5 | 4.4 | 4.0 | 11.0 | 26.2 | 14.1 | 4.4 | 4.4 | 11.6 |
| | curing | | | | | | | | | | |
| | After curing | 36.9 | 46.8 | 4.7 | 4.6 | 16.1 | 48.3 | 13.5 | 4.6 | 4.4 | |
| Push out force | N | 338.2 | 352.2 | 330.0 | 387.0 | 430.0 | 434.0 | 393.0 | 394.0 | 520.0 | 193.0 |
| | N/cm² | 99.5 | 103.6 | 97.1 | 113.8 | 126.5 | 127.6 | 115.6 | 115.8 | 152.8 | 56.8 |
| Drop impact test | Number of | >60 | >60 | >60 | >60 | >60 | >60 | 2 | 2 | 4 | >60 |
| | drops | | | | | | | | | | |

The curable double-sided pressure-sensitive adhesive sheets according to Examples 1 to 6 had glass transition temperatures of −30° C. or lower, had storage moduli of 6.0×10⁴ Pa or more at 70° C., each after curing by irradiation with an ultraviolet ray at a cumulative dose of 3000 mJ/cm², and offered high push out force. The curable double-sided pressure-sensitive adhesive sheets were found not to undergo separation in the drop impact tests and were found to have high adhesiveness and high drop impact resistance.

The sample according to Example 6 had a “push out force (405LED irradiation)” of 398.0 N and 117.1 N/cm².

In contrast, the samples according to Comparative Examples 1 to 3 had glass transition temperatures after curing of higher than −30° C., were found to undergo separation in the drop impact test, and were found to have inferior drop impact resistance. The sample according to Comparative Example 4 had a storage modulus after curing of less than 6.0×10⁴ Pa at 70° C. and was found to have low push out force and insufficient adhesiveness.

### Example 7

The double-sided pressure-sensitive adhesive sheet according to Example 6 was cut into a frame-like piece having a size of 56 mm wide by 98 mm long by 1 mm frame-wide as illustrated in FIG. 7, and this was used as a frame-like double-sided pressure-sensitive adhesive sheet 102. Via the frame-like double-sided pressure-sensitive adhesive sheet 102, a glass plate 103 and a polycarbonate (PC) plate 101 were laminated on each other by compression bonding via one reciprocating movement of a 5-kg roller, and yielded an evaluation sample as illustrated in FIG. 7. The glass plate 103 was Gorilla Glass supplied by Corning Inc. (hereinafter the same), had a size of 60 mm wide by 114 mm long by 1.5 mm thick, and bore a light-shielding print having a coating thickness of 0.05 mm as a light-shielding print portion 105. The polycarbonate (PC) plate 101 had a size of 80 mm wide by 130 mm long by 10 mm thick and had a through hole 104 at the center portion. The through hole 104 had a size of 50 mm by 92 mm.

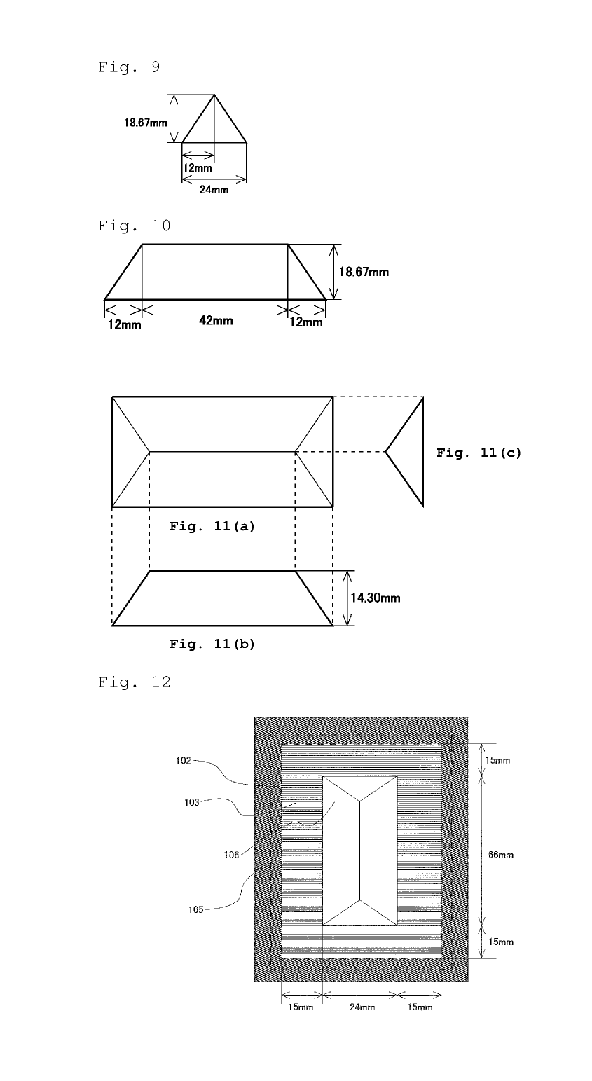

Independently, a 2-mm thick glass mirror was cut to a size illustrated in FIG. 9 and yielded two triangular glass mirrors. Another 2-mm thick glass mirror was cut to a size illustrated in FIG. 10 and yielded two trapezoidal glass mirrors. The triangular glass mirrors and the trapezoidal glass mirrors were assembled as illustrated in FIG. 11 and yielded a prism (mirror prism 106 in FIG. 12).

Twelve (12) hours after the preparation of the evaluation sample, the prism was disposed on the glass side of the evaluation sample in an arrangement as illustrated in FIG. 12. Next, an ultraviolet ray was applied from above to the prism at an irradiance of 300 mW/cm² to a cumulative dose of 5000 mJ/cm² using a metal halide lamp (trade name M3000L/22, supplied by TOSHIBA CORPORATION). The evaluation sample after the ultraviolet irradiation was left stand at an ambient temperature of 23° C. and relative humidity of 50% for 12 hours. The evaluation sample was then subjected to a push out force measurement as follows.

FIGS. 7(a) and 7(b) are a schematic top view and a schematic cross-sectional view taken along the line C-C′, respectively, of the evaluation sample according to Example 7. FIG. 7 illustrates the polycarbonate plate 101, the frame-like double-sided pressure-sensitive adhesive sheet 102, the glass plate 103, and the through hole 104 provided in the polycarbonate plate 101.

The evaluation sample was placed in the universal tensile compression testing machine. A pushing jig 21 shown in the figure and having an area of 39.6 cm² (45 mm by 88 mm) was allowed to pass through the through hole 104 in the polycarbonate plate 101 and to descend at a speed of 10 mm/min. Thus, the glass plate 103 was pushed out to such a direction as to be away from the polycarbonate plate 101. A maximum stress observed until the glass plate 103 and the polycarbonate plate 101 were separated from each other was measured and defined as a push out force. The measurement was performed at an ambient temperature of 23° C. and relative humidity of 50%.

FIG. 8 is a cross-sectional diagram illustrating how to measure the push out force. FIG. 8 illustrates the polycarbonate plate 101, the frame-like double-sided pressure-sensitive adhesive sheet 102, the glass plate 103, the pushing jig 21, and a support 22. The evaluation sample was secured to the support 22 of the tensile compression testing machine as illustrated in FIG. 8. The glass plate 103 of the evaluation sample was pushed out by the pushing jig 21 passed through the through hole 104 in the polycarbonate plate 101. In the push out force measurement, the polycarbonate plate 101 neither warped nor broke due to the load applied by the glass plate 103 as pushed out by the pushing jig 21.

TABLE 3

| | | Example 7 |
|---|---|---|
| Push out force | N | 389.1 |
| | N/cm² | 128 |

Example 7 corresponds to the embodiment in which the light incident angle to a portion to be irradiated is adjusted using a prism.

### INDUSTRIAL APPLICABILITY

The double-sided pressure-sensitive adhesive sheet according to the present invention for securing portable electronic device members can secure a portable electronic device member to a predetermined place. For example, a glass lens and a cabinet in a smartphone can be joined with each other via the double-sided pressure-sensitive adhesive sheet for securing portable electronic device members. Further, radiation is applied via the lens to cure the pressure-sensitive adhesive layer to thereby secure the member (lens).

### REFERENCE SIGNS LIST

1 SUS plate
2 frame-like double-sided pressure-sensitive adhesive sheet
3 glass plate
4 through hole
21 pushing jig
22 support
31 polycarbonate plate
32 frame-like double-sided pressure-sensitive adhesive sheet
33 acrylic plate
4 glass lens
5 cabinet
6 frame-like double-sided pressure-sensitive adhesive sheet
7 black print
101 polycarbonate plate
102 frame-like double-sided pressure-sensitive adhesive sheet
103 glass plate
104 through hole
105 light-shielding print portion
106 mirror prism

1. A double-sided pressure-sensitive adhesive sheet for securing portable electronic device members, the double-sided pressure-sensitive adhesive sheet comprising
an acrylic pressure-sensitive adhesive layer being curable by irradiation with radiation,
the acrylic pressure-sensitive adhesive layer, after curing, having a glass transition temperature of −30° C. or lower,
the acrylic pressure-sensitive adhesive layer, after curing, having a storage modulus of 6.0×104 Pa or more at 70° C.

2. The double-sided pressure-sensitive adhesive sheet according to claim 1 for securing portable electronic device members,
wherein the acrylic pressure-sensitive adhesive layer, after curing, has a glass transition temperature of −30° C. or lower, where the curing is performed by irradiating the acrylic pressure-sensitive adhesive layer with an ultraviolet ray at a cumulative dose of 3000 mJ/cm2 or more, and
wherein the acrylic pressure-sensitive adhesive layer, after curing, has a storage modulus of 6.0×104 Pa or more at 70° C., where the curing is performed by irradiating the acrylic pressure-sensitive adhesive layer with an ultraviolet ray at a cumulative dose of 3000 mJ/cm2 or more.

3. The double-sided pressure-sensitive adhesive sheet according to claim 1 for securing portable electronic device members,
wherein the acrylic pressure-sensitive adhesive layer is derived from a radiation-curable pressure-sensitive adhesive composition comprising:
an acrylic copolymer;
at least one of a multifunctional acrylic oligomer (m1) and a basic monomer (m2); and
a photoinitiator.

4. The double-sided pressure-sensitive adhesive sheet according to claim 3 for securing portable electronic device members, wherein the multifunctional acrylic oligomer (m1) contains three or more (meth)acryloyl groups per molecule.

5. The double-sided pressure-sensitive adhesive sheet according to claim 3 for securing portable electronic device members, wherein the multifunctional acrylic oligomer (m1) has a weight-average molecular weight of 500 to 30000.

6. The double-sided pressure-sensitive adhesive sheet according to claim 3 for securing portable electronic device members, wherein the radiation-curable pressure-sensitive adhesive composition comprises:
5 to 30 parts by mass of the multifunctional acrylic oligomer (m1); and
0.05 to 5 parts by mass of the photoinitiator,
per 100 parts by mass of the acrylic copolymer.

7. The double-sided pressure-sensitive adhesive sheet according to claim 3 for securing portable electronic device members, wherein the basic monomer (m2) contains at least one of an amido group and an amino group in molecule.

8. The double-sided pressure-sensitive adhesive sheet according to claim 3 for securing portable electronic device members, wherein the basic monomer (m2) has a boiling point of 120° C. or higher.

9. The double-sided pressure-sensitive adhesive sheet according to claim 3 for securing portable electronic device members, wherein the acrylic copolymer is derived from components including 0.5% to 10% by mass of an acidic-group-containing monomer.

10. The double-sided pressure-sensitive adhesive sheet according to claim 3 for securing portable electronic device members, wherein the radiation-curable pressure-sensitive adhesive composition comprises: 0.1 to 20 parts by mass of the basic monomer (m2); and
0.05 to 5 parts by mass of the photoinitiator,
per 100 parts by mass of the acrylic copolymer.

11. The double-sided pressure-sensitive adhesive sheet according to claim 3 for securing portable electronic device members, wherein the acrylic copolymer has a weight-average molecular weight of 40×104 to 200×104.

12. A method for producing a portable electronic device, the method comprising:
(a) holding a portable electronic device member using the double-sided pressure-sensitive adhesive sheet according to claim 1 for securing portable electronic device members; and
(b) applying radiation to the double-sided pressure-sensitive adhesive sheet after the step (a) to secure the member.

13. The method according to claim 12 for producing a portable electronic device, wherein the radiation is applied so that a light incident angle to a portion to be irradiated is 8° to 20°.

14. The method according to claim 13 for producing a portable electronic device, wherein a prism is used to control the light incident angle within a range of 8° to 20°.
